(19) United States
(12) Patent Application Publication
(10) Pub. No.: US 2026/0235047 A1
(43) Pub. Date: Aug. 13, 2026

(54) PASSENGER COMPARTMENT AND METHOD FOR MANUFACTURING PASSENGER COMPARTMENT

(71) Applicant: MITSUBISHI HEAVY INDUSTRIES COMPRESSOR CORPORATION, Hiroshima-shi (JP)

(72) Inventors: Makio Morimoto, Hiroshima-shi (JP); Akito Kunimoto, Hiroshima-shi (JP)

(73) Assignee: MITSUBISHI HEAVY INDUSTRIES COMPRESSOR CORPORATION, Hiroshima-shi (JP)

(21) Appl. No.: 19/155,178

(22) PCT Filed: Jan. 31, 2024
(86) PCT No.: PCT/JP2024/003064

§ 371 Date: Aug. 8, 2025

(30) Foreign Application Priority Data
Feb. 13, 2023 (JP) 2023-019993

(51) Int. Cl. F01D 25/24

(52) U.S. Cl. CPC F01D 25/24; F05D 2220/31; F05D 2230/232; F05D 2230/25

(57) ABSTRACT

A passenger compartment includes an upper-half valve casing. The upper-half valve casing has an inlet flow path formed linearly in a first direction, an inlet opening, a plurality of exhaust flow paths, a member insertion hole, and an upper-half main steam supply path. The plurality of exhaust flow paths are disposed at positions set apart from the member insertion hole. The upper-half main steam supply path communicates with the exterior of the upper-half valve casing only on one side in the axial direction. The upper-half valve casing has an upper-half valve casing body in which a plurality of flow paths are formed in the interior thereof, an upper-half blocking member that forms the upper-half main steam supply path, and a welded part where the upper-half valve casing body and the upper-half blocking member are fixed by welding.

### TECHNICAL FIELD

The present disclosure relates to a casing and a method for manufacturing a casing.

The present application claims priority with respect to Japanese Patent Application No. 2023-019993 filed in Japan on Feb. 13, 2023, the contents of which are incorporated herein by reference.

### BACKGROUND ART

In a steam turbine, a casing accommodating a rotor generally has a structure formed by casting. The casing can be vertically divided into an upper-half body and a lower-half casing. The upper-half body and the lower-half casing are integrally formed by casting, respectively. However, in a case where the casing is formed by casting, a mold is required to be prepared. It takes a very long time to manufacture a large mold to form a large metal such as the casing.

On the contrary, for example, PTL 1 discloses a method for manufacturing a casing in which a plurality of metals for configuring a casing 3 are manufactured by at least two types of manufacturing methods among forging, steel plate processing, casting, and a molten metal lamination method. In the method for manufacturing the casing in PTL 1, there is no need to manufacture the entire casing by casting, and thus it is possible to reduce labor and costs required for manufacturing a mold.

### CITATION LIST

### Patent Literature

[PTL 1] Japanese Unexamined Patent Application Publication No. 2021-134679

### SUMMARY OF INVENTION

### Technical Problem

Incidentally, in a case where the casing is not formed by casting, it is difficult to manufacture a complex structure like the casting, and thus a shape of each part needs to be simplified. However, in a case of a regulating valve disposed near an inlet of a fluid in the steam turbine, a regulating valve casing has a structure in which a plurality of flow paths need to be formed inside the regulating valve casing, and thus it is very difficult to perform the simplification.

The present disclosure provides a casing and a method for manufacturing a casing in which a plurality of flow paths can be formed inside the casing without using casting.

### Solution to Problem

A casing according to the present disclosure has a valve casing of a regulating valve in which an upper-half valve casing above in a vertical direction and a lower-half valve casing below in the vertical direction are included and a supply amount of steam to be supplied in a steam turbine is adjustable, a casing body that has an upper-half body above in the vertical direction and a lower-half body below in the vertical direction, is formed in a tubular shape centered on an axis line extending in an axial direction, and is connected to the valve casing, a pair of upper-half flanges that is connected to the upper-half valve casing and the upper-half body at both end portions in a circumferential direction around the axis line with respect to the upper-half body, and extends in the axial direction, and a pair of lower-half flanges that is connected to the lower-half valve casing and the lower-half body at both end portions in the circumferential direction with respect to the lower-half body, and extends in the axial direction, in which the upper-half body and the lower-half body each have a plurality of body block portions arranged in the axial direction, the upper-half valve casing has an inlet flow path that allows a valve body to be disposed and is formed in a linear shape in a first direction orthogonal to the vertical direction and the axial direction, an inlet opening that allows a fluid to flow into the inlet flow path and causes an end portion of the inlet flow path in the first direction to communicate with an outside, a plurality of exhaust flow paths that communicate with the inlet flow path at positions separated from each other in the first direction such that the fluid in the inlet flow path is caused to flow out in the vertical direction, a member insertion hole that causes the inlet flow path to communicate with the outside at a position facing the plurality of exhaust flow paths in the vertical direction, and an upper-half main steam supply path that is curved and communicates with a part of the plurality of exhaust flow paths, the lower-half valve casing has a lower-half main steam supply path that is curved and communicates with a remaining part of the plurality of exhaust flow paths, at least a part of the plurality of exhaust flow paths is disposed at a position separated from the member insertion hole when viewed from the vertical direction, the upper-half main steam supply path and the lower-half main steam supply path communicate with an outside of the upper-half valve casing and the lower-half valve casing only on one side in the axial direction, and the upper-half valve casing has an upper-half valve casing main body in which the inlet flow path, the inlet opening, the exhaust flow path, and the member insertion hole are formed, an upper-half closing member that is disposed below the upper-half valve casing main body in the vertical direction to form, together with the upper-half valve casing main body, the upper-half main steam supply path, and a welding portion that fixes the upper-half valve casing main body and the upper-half closing member to each other by welding.

A method for manufacturing a casing according to the present disclosure including a valve casing of a regulating valve in which an upper-half valve casing above in a vertical direction and a lower-half valve casing below in the vertical direction are included and a supply amount of steam to be supplied in a steam turbine is adjustable, a casing body that has an upper-half body above in the vertical direction and a lower-half body below in the vertical direction, is formed in a tubular shape centered on an axis line extending in an axial direction, and is connected to the valve casing, a pair of upper-half flanges that is connected to the upper-half valve casing and the upper-half body at both end portions in a circumferential direction around the axis line with respect to the upper-half body, and extends in the axial direction, and a pair of lower-half flanges that is connected to the lower-half valve casing and the lower-half body at both end portions in the circumferential direction with respect to the lower-half body, and extends in the axial direction, in which the upper-half body and the lower-half body each have a plurality of body block portions arranged in the axial direction, the upper-half valve casing has an inlet flow path that allows a valve body to be disposed and is formed in a linear shape in a first direction orthogonal to the vertical direction and the axial direction, an inlet opening that allows a fluid to flow into the inlet flow path and causes an end portion of the inlet flow path in the first direction to communicate with an outside, a plurality of exhaust flow paths that communicate with the inlet flow path at positions separated from each other in the first direction such that the fluid in the inlet flow path is caused to flow out in the vertical direction, a member insertion hole that causes the inlet flow path to communicate with the outside at a position facing the plurality of exhaust flow paths in the vertical direction, and an upper-half main steam supply path that is curved and communicates with a part of the plurality of exhaust flow paths, the lower-half valve casing has a lower-half main steam supply path that is curved and communicates with a remaining part of the plurality of exhaust flow paths, at least a part of the plurality of exhaust flow paths is disposed at a position separated from the member insertion hole when viewed from the vertical direction, the upper-half main steam supply path and the lower-half main steam supply path communicate with an outside of the upper-half valve casing and the lower-half valve casing only on one side in the axial direction, and the upper-half valve casing has an upper-half valve casing main body in which the inlet flow path, the inlet opening, the exhaust flow path, and the member insertion hole are formed, an upper-half closing member that is disposed below the upper-half valve casing main body in the vertical direction to form, together with the upper-half valve casing main body, the upper-half main steam supply path, and a welding portion that fixes the upper-half valve casing main body and the upper-half closing member to each other by welding, the manufacturing method includes a step of manufacturing the upper-half valve casing main body and the upper-half closing member, and a step of welding the upper-half valve casing main body and the upper-half closing member to each other, in which in the step of manufacturing, one forged member formed by forging is cut to manufacture the upper-half valve casing main body and the upper-half closing member.

### Advantageous Effects of Invention

According to the casing and the method for manufacturing a casing of the present disclosure, it is possible to form the plurality of flow paths inside the casing

### BRIEF DESCRIPTION OF DRAWINGS

FIG. 1 is a schematic diagram showing a schematic configuration of a steam turbine including a casing according to the present embodiment.

FIG. 2 is a perspective view of the casing according to the present embodiment.

FIG. 3 is a perspective view of an upper-half casing according to the present embodiment.

FIG. 4 is a perspective view of a lower-half casing according to the present embodiment.

FIG. 5 is a sectional view taken along a line IV-IV in FIG. 1 showing an inlet valve casing according to the present embodiment.

FIG. 6 is a perspective view of a state where an upper-half valve casing according to the present embodiment is viewed obliquely from below.

FIG. 7 is a top view of a state where the upper-half valve casing according to the present embodiment is viewed from above in a vertical direction.

FIG. 8 is a perspective view of a state where a lower-half valve casing according to the present embodiment is viewed obliquely from below.

FIG. 9 is a sectional view taken along a line X-X in FIG. 1 showing an extraction valve casing according to the present embodiment.

FIG. 10 is a sectional view taken along a line XI-XI in FIG. 1 showing the extraction valve casing according to the present embodiment.

FIG. 11 is a perspective view of a state where an upper-half extraction valve casing according to the present embodiment is viewed obliquely from below.

FIG. 12 is a perspective view of a state where a lower-half extraction valve casing according to the present embodiment is viewed obliquely from below.

FIG. 13 is an exploded perspective view of a plurality of metal components configuring the upper-half casing according to the present embodiment.

FIG. 14 is an exploded perspective view of a plurality of metal components configuring the lower-half casing according to the present embodiment.

FIG. 15 is a flowchart showing a procedure of a method for manufacturing the casing according to the present embodiment.

FIG. 16 is a flowchart showing a procedure of a step of forming a plurality of metals according to the present embodiment.

FIG. 17 is a flowchart showing a procedure of a step of forming the upper-half valve casing according to the present embodiment.

### DESCRIPTION OF EMBODIMENTS

Hereinafter, embodiments for implementing a valve casing, a casing 3 of a steam turbine 1, and a method for manufacturing the casing 3 according to the present disclosure will be described with reference to accompanying drawings. However, the present disclosure is not limited to the embodiments only.

### Configuration of Steam Turbine

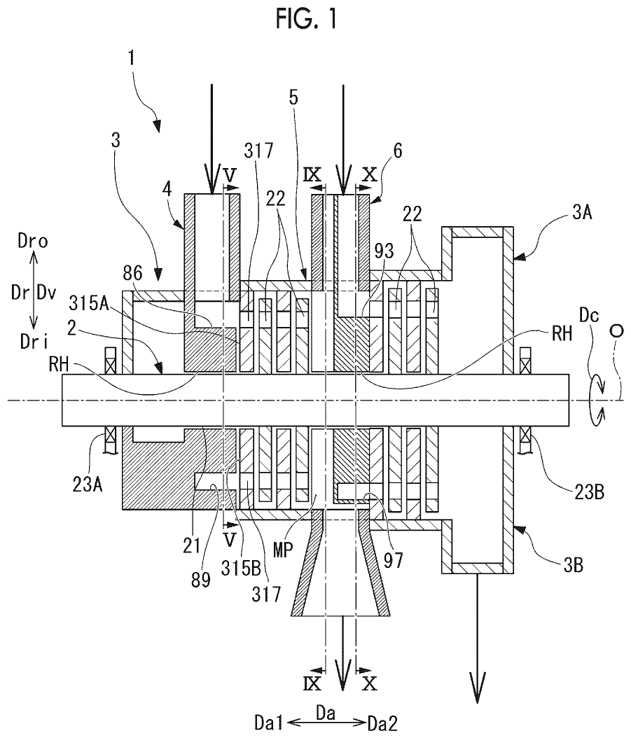

In the present embodiment, the casing 3 is employed for the steam turbine 1. As shown in FIG. 1, the steam turbine 1 includes a rotor 2 and the casing 3.

The rotor 2 includes a rotary shaft 21 and rotor blades 22. The rotary shaft 21 is formed in a columnar shape extending in an axial direction Da with an axis line O as a center. Both end portions of the rotary shaft 21 are respectively supported by a first bearing 23A and a second bearing 23B in a rotatable manner around the axis line O. The first bearing 23A and the second bearing 23B are fixed to bearing devices (not shown) separated from the casing 3. The rotor blades 22 are disposed to configure a plurality of stages at spacings in the axial direction Da. Each rotor blade 22 is fixed to an outer peripheral surface of the rotary shaft 21 to extend toward an outer-side Dro in a radial direction Dr.

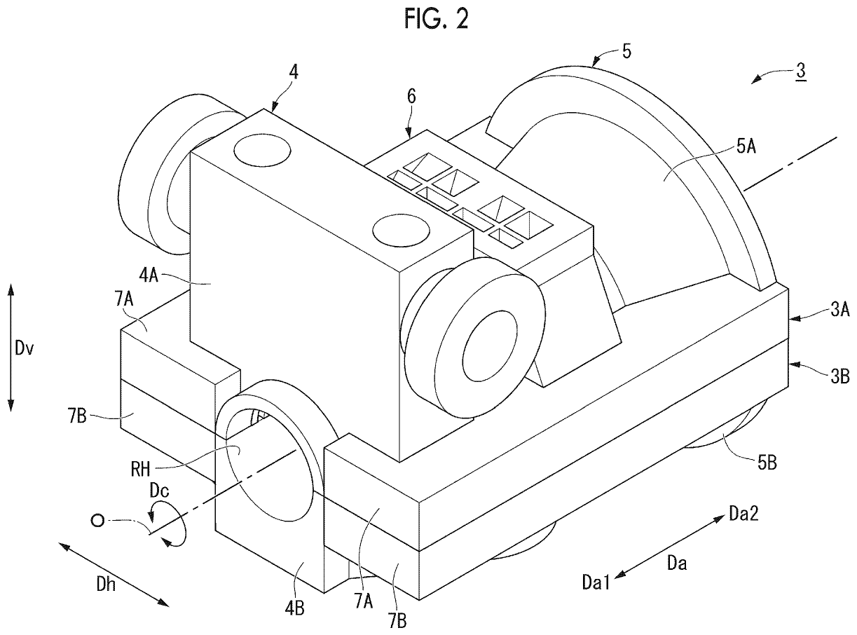

In the following, a direction in which the axis line O extends is referred to as the axial direction Da. A radial direction with reference to the axis line O is simply referred to as the radial direction Dr. A portion in the radial direction Dr, the portion being a paper surface up-down direction in FIG. 1, is referred to as a vertical direction Dv. A portion of the radial direction Dr, the portion being a direction orthogonal to the vertical direction Dv, is referred to as a horizontal direction Dh (refer to FIG. 2), which is a width direction of the steam turbine 1. Further, a direction around the rotor 2 centered on the axis line O is referred to as a circumferential direction Dc. Further, a first side Dal in the axial direction Da is an upstream side in a flow direction of steam (fluid) flowing inside the casing 3. Further, a second side Da2 in the axial direction Da is a downstream side in the flow direction of the steam flowing inside the casing 3.

### Configuration of Casing

The casing 3 is disposed to cover the rotor 2. As shown in FIGS. 2 to 4, the casing 3 can be divided into an upper-half casing 3A and a lower-half casing 3B with reference to a horizontal plane including the axis line O. As shown in FIG. 1, an upper-half diaphragm 315A having a semicircular ring shape when viewed from the axial direction Da is fixed to an inner-side Dri of the upper-half casing 3A in the radial direction Dr. A lower-half diaphragm 315B having the semicircular ring shape when viewed from the axial direction Da is fixed to the inner-side Dri of the lower-half casing 3B in the radial direction Dr. The upper-half diaphragm 315A and the lower-half diaphragm 315B are disposed on the first side Dal in the axial direction Da with respect to the rotor blades 22 of each stage. A plurality of stator vanes 317 that are arranged in the circumferential direction Dc are disposed at a position of the rotor blade 22 on the first side Dal in the axial direction Da in the upper-half diaphragm 315A and the lower-half diaphragm 315B. Further, a rotary shaft insertion hole RH into which the rotary shaft 21 is inserted and a main steam flow path MP through which high-pressure steam flows are formed inside the casing 3. The rotary shaft insertion hole RH penetrates the casing 3 in the axial direction Da. The rotary shaft insertion hole RH is a through-hole having a circular cross-sectional shape centered on the axis line O. The main steam flow path MP is a space having a cross-sectional ring shape centered on the axis line O to cover the rotary shaft insertion hole RH from the outer-side Dro in the radial direction Dr. The rotor blades 22 and the stator vanes 317 are disposed in the main steam flow path MP.

As shown in FIG. 2, the casing 3 of the present embodiment includes an inlet valve casing (valve casing) 4, a casing body 5, an extraction valve casing 6, a pair of upper-half flanges 7A, and a pair of lower-half flanges 7B.

### Configuration of Inlet Valve Casing

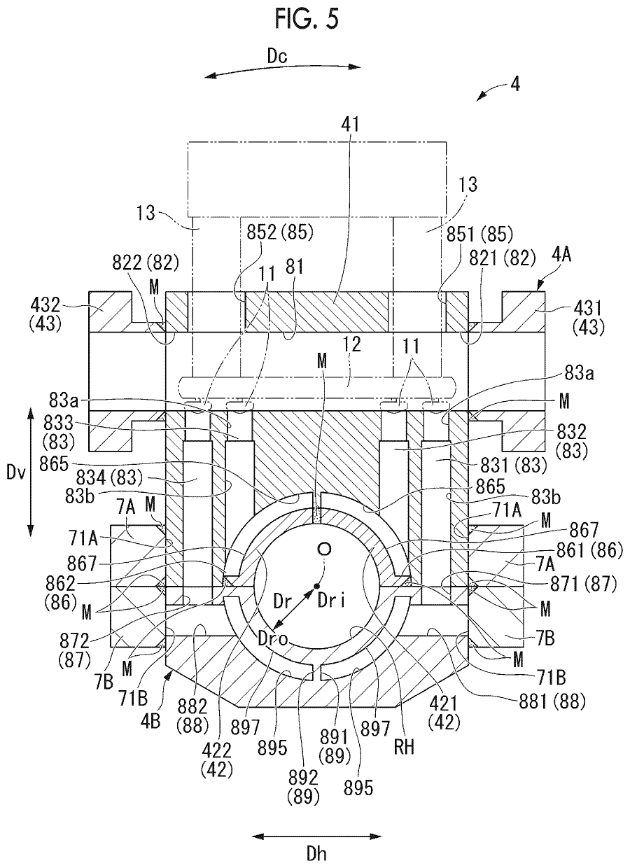

The inlet valve casing 4 configures a valve casing of a regulating valve of the steam turbine 1 in which a supply amount of the steam to be supplied is adjustable. In the inlet valve casing 4, a pressure or a flow rate of the steam flowing into the casing body 5 is adjustable. A drive mechanism (not shown) of a pressure regulating valve can be connected to the inlet valve casing 4. A space serving as a flow path through which the steam flows is formed inside the inlet valve casing 4. Further, as shown in FIG. 5, a surface configuring a part of the rotary shaft insertion hole RH is formed inside the inlet valve casing 4 of the present embodiment. The inlet valve casing 4 has an upper-half valve casing 4A above in the vertical direction Dv and a lower-half valve casing 4B below in the vertical direction Dv. The inlet valve casing 4 can be divided into the upper-half valve casing 4A and the lower-half valve casing 4B with reference to the horizontal plane including the axis line O.

The upper-half valve casing 4A is disposed above in the vertical direction Dv with reference to the axis line O. The upper-half valve casing 4A is recessed upward in the vertical direction Dv when viewed from the axial direction Da to form an upper half of the rotary shaft insertion hole RH in the inlet valve casing 4. Further, the upper-half valve casing 4A has an inlet flow path 81, an inlet opening 82, a plurality of exhaust flow paths 83, a member insertion hole 85, and an upper-half main steam supply path 86 inside.

The inlet flow path 81 is a flow path into which the steam flowing from the inlet opening 82 flows. The inlet flow path 81 is formed linearly in a first direction. The first direction is the direction orthogonal to the vertical direction Dv, which is the horizontal direction Dh of the present embodiment. The inlet flow path 81 is formed as a through-hole penetrating the upper-half valve casing 4A in the horizontal direction Dh. The inlet flow path 81 is a space in which a plurality of valve bodies 11 and an inner bar 12 can be disposed.

The plurality of valve bodies 11 are members that can close the exhaust flow path 83 by coming into contact with a valve seat portion (not shown) disposed in the exhaust flow path 83. The inner bar 12 is connected to the plurality of valve bodies 11. The inner bar 12 causes the plurality of valve bodies 11 to move together. The inner bar 12 is a rod-shaped member extending in the horizontal direction Dh inside the inlet flow path 81.

The inlet opening 82 allows the steam to flow into the inlet flow path 81 from the outside. The inlet opening 82 is formed at an end portion of the inlet flow path 81 in the horizontal direction Dh. The inlet opening 82 causes the end portion of the inlet flow path 81 and the outside of the upper-half valve casing 4A to communicate with each other. The inlet opening 82 is connectable to a line, such as a pipe, connected to a steam supply source (not shown). The inlet opening 82 of the present embodiment has a first inlet opening 821 formed at one end portion of the inlet flow path 81 in the horizontal direction Dh, and a second inlet opening 822 formed at the other end portion of the inlet flow path 81 in the horizontal direction Dh. The first inlet opening 821 and the second inlet opening 822 are formed in a size that allows the inner bar 12 to be inserted through the inlet openings.

The plurality of exhaust flow paths 83 communicate with the inlet flow path 81 at positions separated from each other in the horizontal direction Dh to cause the steam in the inlet flow path 81 to flow out in the vertical direction Dv. The plurality of exhaust flow paths 83 extend in a linear shape in the vertical direction Dv to be orthogonal to the inlet flow path 81. The plurality of exhaust flow paths 83 are formed on the inner-side Dri in the horizontal direction Dh with respect to the first inlet opening 821 and the second inlet opening 822. The plurality of exhaust flow paths 83 cause the steam that has flowed into the inlet flow path 81 to flow downward in the vertical direction Dv. In the present embodiment, the plurality (four in the present embodiment) of exhaust flow paths 83 have a first exhaust flow path 831, a second exhaust flow path 832, a third exhaust flow path 833, and a fourth exhaust flow path 834 in order from a position close to the first inlet opening 821 in the horizontal direction Dh. Each exhaust flow path 83 is formed by a small-diameter flow path 83a connected to the inlet flow path 81 and a large-diameter flow path 83b located below the small-diameter flow path 83a in the vertical direction Dv. The large-diameter flow path 83b is formed to have a larger flow path diameter than the small-diameter flow path 83a.

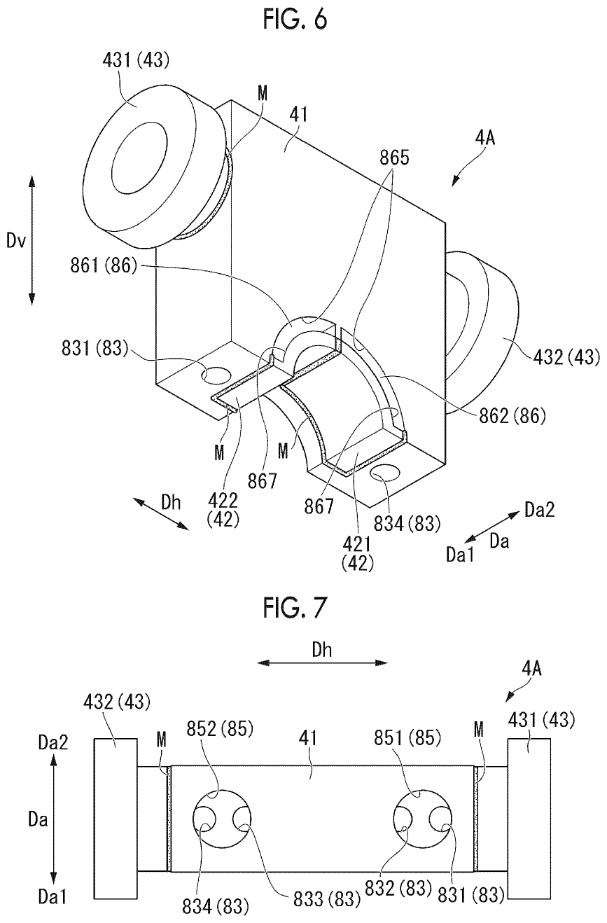

As shown in FIGS. 5 and 6, the first exhaust flow path 831 and the fourth exhaust flow path 834 connect a horizontal plane of the upper-half valve casing 4A (plane facing downward in the vertical direction Dv, which comes into contact with the lower-half valve casing 4B) and the inlet flow path 81. As shown in FIG. 5, the second exhaust flow path 832 and the third exhaust flow path 833 connect the inlet flow path 81 and the upper-half main steam supply path 86.

The member insertion hole 85 causes the inlet flow path to communicate 81 with the outside at a position facing the plurality of exhaust flow paths 83 in the vertical direction Dv. The member insertion hole 85 extends linearly in the vertical direction Dv from an upper surface of the upper-half valve casing 4A (plane facing upward in the vertical direction Dv) to the inlet flow path 81. The member insertion hole 85 allows the rod 13 to be inserted therethrough. The rod 13 is formed in a columnar shape extending in the vertical direction Dv. The rod 13 is formed of, for example, metal or the like. A tip of the rod 13 is connected to the inner bar 12 in a state of being inserted through the member insertion hole 85. The rod 13 is relatively moved in the vertical direction Dv with respect to the inlet valve casing 4 to cause the inner bar 12 to relatively move with respect to the exhaust flow path 83. In the present embodiment, a pair of rods 13 is connected to the inner bar 12. Therefore, as the member insertion holes 85 of the present embodiment, a plurality of member insertion holes 85 of a first member insertion hole 851 and a second member insertion hole 852 are provided. The first member insertion hole 851 is formed at a position close to the first inlet opening 821 in the horizontal direction Dh. The second member insertion hole 852 is formed at a position close to the second inlet opening 822 in the horizontal direction Dh. The first member insertion hole 851 and the second member insertion hole 852 are formed to be separated from each other in the horizontal direction Dh.

As shown in FIG. 7, a size of one member insertion hole 85 is formed to be larger than that of one exhaust flow path 83. Further, the member insertion hole 85 is formed such that a center position thereof is deviated from that of the exhaust flow path 83 when viewed from the vertical direction Dv. The plurality of exhaust flow paths 83 are disposed at positions where at least a part of the plurality of exhaust flow paths 83 is separated from the member insertion hole 85, when viewed from the vertical direction Dv. In the present embodiment, the first exhaust flow path 831 and the second exhaust flow path 832 are formed to be deviated in the horizontal direction Dh such that a part of the first exhaust flow path 831 and the second exhaust flow path 832 is separated from the first member insertion hole 851 when viewed from the vertical direction Dv. The third exhaust flow path 833 and the fourth exhaust flow path 834 are formed to be deviated in the horizontal direction Dh such that a part of the third exhaust flow path 833 and the fourth exhaust flow path 834 is separated from the second member insertion hole 852 when viewed from the vertical direction Dv.

As shown in FIGS. 1 and 5, the upper-half main steam supply path 86 is capable of supplying, to the main steam flow path MP, the steam that has flowed through a part of the plurality of exhaust flow paths 83. As shown in FIG. 5, the upper-half main steam supply path 86 is formed below the plurality of exhaust flow paths 83 in the vertical direction Dv. The upper-half main steam supply path 86 is curved and communicates with a part of the plurality of exhaust flow paths 83. The upper-half main steam supply path 86 is formed in an arc shape to surround the rotary shaft insertion hole RH from above in the vertical direction Dv, when viewed from the axial direction Da. As shown in FIGS. 5 and 6, the upper-half main steam supply path 86 communicates with the outside of the upper-half valve casing 4A only on one side (the second side Da2) in the axial direction Da. That is, the upper-half main steam supply path 86 is formed not to penetrate the upper-half valve casing 4A in the axial direction Da.

Further, the upper-half valve casing 4A has an upper-half outer-side inner peripheral surface 865 (outer-side inner peripheral surface) and an upper-half inner-side inner peripheral surface 867 (inner-side inner peripheral surface). The upper-half outer-side inner peripheral surface 865 is a curved surface on the outer-side Dro in the radial direction Dr, which faces the steam flowing in the upper-half main steam supply path 86. At least a part (an upper end portion in the vertical direction Dv in the present embodiment) of the upper-half outer-side inner peripheral surface 865 in the upper-half main steam supply path 86 faces downward in the vertical direction Dv. The upper-half inner-side inner peripheral surface 867 is a curved surface on the inner-side Dri in the radial direction Dr, which faces the upper-half outer-side inner peripheral surface 865. At least a part (an upper end portion in the vertical direction Dv in the present embodiment) of the upper-half inner-side inner peripheral surface 867 in the upper-half main steam supply path 86 faces upward in the vertical direction Dv. The upper-half inner-side inner peripheral surface 867 faces the steam flowing in the upper-half main steam supply path 86. That is, in the upper-half main steam supply path 86, the steam flows through a space between the upper-half outer-side inner peripheral surface 865 and the upper-half inner-side inner peripheral surface 867. In the present embodiment, as the upper-half main steam supply path 86, a plurality of upper-half main steam supply paths 86 of a first upper-half main steam supply path 861 connected to the second exhaust flow path 832 and a second upper-half main steam supply path 862 connected to the third exhaust flow path 833 are provided.

The first upper-half main steam supply path 861 is formed at a position close to the first inlet opening 821 with respect to the axis line O in the horizontal direction Dh, when viewed from the first side Dal in the axial direction Da. The first upper-half main steam supply path 861 is connected to the second exhaust flow path 832 at a lower end in the vertical direction Dv. That is, an opening of the second exhaust flow path 832 is formed on the upper-half outer-side inner peripheral surface 865 of the first upper-half main steam supply path 861. The first upper-half main steam supply path 861 extends in an arc shape to approach the second upper-half main steam supply path 862 upward in the vertical direction Dv from a position connected to the second exhaust flow path 832.

The second upper-half main steam supply path 862 is formed at a position close to the second inlet opening 822 with respect to the axis line O in the horizontal direction Dh, when viewed from the first side Dal in the axial direction Da. The second upper-half main steam supply path 862 is formed to be separated from the first upper-half main steam supply path 861 in the horizontal direction Dh. The second upper-half main steam supply path 862 is connected to the third exhaust flow path 833 at a lower end in the vertical direction Dv. That is, an opening of the third exhaust flow path 833 is formed on the upper-half outer-side inner peripheral surface 865 of the second upper-half main steam supply path 862. The second upper-half main steam supply path 862 extends in an arc shape to approach the first upper-half main steam supply path 861 upward in the vertical direction Dv from a position connected to the third exhaust flow path 833.

Further, as shown in FIGS. 5 to 7, the upper-half valve casing 4A is formed by joining a plurality of members by welding. The upper-half valve casing 4A of the present embodiment has an upper-half valve casing main body 41, an upper-half closing member 42, and an upper-half inlet nozzle 43. That is, the upper-half valve casing 4A further has a welding portion M that fixes the upper-half valve casing main body 41, the upper-half closing member 42, and the upper-half inlet nozzle 43 to each other by welding.

The upper-half valve casing main body 41 is formed by forging. The upper-half valve casing main body 41 is not formed by joining a plurality of members by welding or the like, and is formed of only one forged member. The inlet flow path 81, the plurality of inlet openings 82, the plurality of exhaust flow paths 83, and the member insertion hole 85 are formed inside the upper-half valve casing main body 41. Further, the upper-half valve casing main body 41 is formed with the upper-half outer-side inner peripheral surface 865 in the upper-half main steam supply path 86. In the upper-half valve casing main body 41, the upper-half outer-side inner peripheral surface 865 is formed as an outer surface (surface exposed to the outside) facing downward in the vertical direction Dv. In the upper-half valve casing main body 41, the upper-half outer-side inner peripheral surface 865 of the first upper-half main steam supply path 861 and the upper-half outer-side inner peripheral surface 865 of the second upper-half main steam supply path 862 are formed to be separated from each other in the horizontal direction Dh.

Each upper-half closing member 42 is formed by forging. The upper-half closing member 42 is not formed by joining a plurality of members by welding or the like, and is formed only of one forged member. The upper-half closing member 42 is disposed below the upper-half valve casing main body 41 in the vertical direction Dv. The upper-half closing member 42 is welded to the upper-half valve casing main body 41 to form the upper-half main steam supply path 86, together with the upper-half valve casing main body 41. In the present embodiment, as the upper-half closing member 42, a plurality of upper-half closing members 42 of a first upper-half closing member 421 and a second upper-half closing member 422 are provided.

The first upper-half closing member 421 has the upper-half inner-side inner peripheral surface 867 of the first upper-half main steam supply path 861. In the first upper-half closing member 421, the upper-half inner-side inner peripheral surface 867 is formed as an outer surface facing upward in the vertical direction Dv. The first upper-half closing member 421 is disposed below the upper-half valve casing main body 41 in the vertical direction Dv to form the first upper-half main steam supply path 861. The first upper-half closing member 421 and the upper-half valve casing main body 41 are joined to each other by welding. Therefore, the welding portion M is formed between the first upper-half closing member 421 and the upper-half valve casing main body 41.

The second upper-half closing member 422 has the upper-half inner-side inner peripheral surface 867 of the second upper-half main steam supply path 862. In the second upper-half closing member 422, the upper-half inner-side inner peripheral surface 867 is formed as an outer surface facing upward in the vertical direction Dv. The second upper-half closing member 422 is disposed below the upper-half valve casing main body 41 in the vertical direction Dv to form the second upper-half main steam supply path 862. The second upper-half closing member 422, the first upper-half closing member 421, and the upper-half valve casing main body 41 are joined to each other by welding. Therefore, the welding portion M is formed between the second upper-half closing member 422, the first upper-half closing member 421, and the upper-half valve casing main body 41. The second upper-half closing member 422 is disposed to be separated from the first upper-half closing member 421 in the horizontal direction Dh such that the first upper-half main steam supply path 861 and the second upper-half main steam supply path 862 are partitioned in the horizontal direction Dh by the welding portion M.

The upper-half inlet nozzles 43 are respectively formed by forging. The upper-half inlet nozzle 43 is not formed by joining a plurality of members by welding or the like, and is formed of only one forged member. The upper-half inlet nozzle 43 is formed in a cylindrical shape. The upper-half inlet nozzle 43 is disposed adjacent to the upper-half valve casing main body 41 in the horizontal direction Dh. The upper-half inlet nozzle 43 is welded to the upper-half valve casing main body 41 in a state where an opening thereof faces a side surface of the upper-half valve casing main body 41, and thus a flow path communicating with the inlet opening 82 is formed inside the upper-half inlet nozzle 43. In the present embodiment, as the upper-half inlet nozzles 43, a plurality of upper-half inlet nozzles 43 of a first upper-half inlet nozzle 431 and a second upper-half inlet nozzle 432 are provided.

The first upper-half inlet nozzle 431 is connected to the first inlet opening 821. A through-hole having the same size as the first inlet opening 821 is formed inside the first upper-half inlet nozzle 431. The first upper-half inlet nozzle 431 and the upper-half valve casing main body 41 are joined to each other by welding. Therefore, the welding portion M is formed between the first upper-half inlet nozzle 431 and the upper-half valve casing main body 41.

The second upper-half inlet nozzle 432 is connected to the second inlet opening 822. A through-hole having the same size as the second inlet opening 822 is formed inside the second upper-half inlet nozzle 432. The second upper-half inlet nozzle 432 and the upper-half valve casing main body 41 are joined to each other by welding. Therefore, the welding portion M is formed between the second upper-half inlet nozzle 432 and the upper-half valve casing main body 41.

As shown in FIG. 2, the lower-half valve casing 4B is disposed below in the vertical direction Dv with reference to the axis line O. As shown in FIG. 5, the lower-half valve casing 4B is recessed downward in the vertical direction Dv when viewed from the axial direction Da to form a lower-half of the rotary shaft insertion hole RH in the inlet valve casing 4. The lower-half valve casing 4B is formed by forging. The lower-half valve casing 4B is not formed by joining a plurality of members by welding or the like, and is formed of only one forged member. Further, a connection flow path 87, a lower-half valve communication hole 88, and a lower-half main steam supply path 89 are provided inside the lower-half valve casing 4B of the present embodiment.

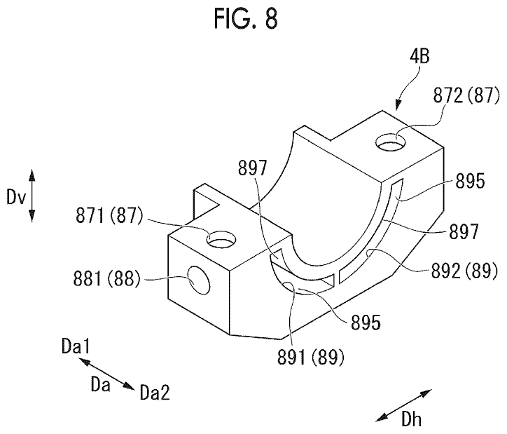

The connection flow path 87 is capable of supplying, to the lower-half valve communication hole 88, the steam that has flowed through the first exhaust flow path 831 and the fourth exhaust flow path 834. As shown in FIGS. 5 and 8, the connection flow path 87 connects a horizontal plane of the lower-half valve casing 4B (plane facing upward in the vertical direction Dv, which comes into contact with the upper-half valve casing 4A) and the lower-half valve communication hole 88. The connection flow path 87 extends in a linear shape downward in the vertical direction Dv from the horizontal plane of the lower-half valve casing 4B. The connection flow path 87 extends perpendicular to the horizontal plane of the lower-half valve casing 4B. In the present embodiment, as the connection flow path 87, a plurality of connection flow paths 87 of a first connection flow path 871 and a second connection flow path 872 are provided.

The first connection flow path 871 connects the first exhaust flow path 831 and the lower-half valve communication hole 88. The first connection flow path 871 is formed such that a position of the first exhaust flow path 831 in the horizontal direction Dh matches with a position of the first connection flow path 871, when viewed from the axial direction Da. Therefore, the first connection flow path 871 is connected to the first exhaust flow path 831 by the lower-half valve casing 4B being combined with the upper-half valve casing 4A.

The second connection flow path 872 connects the fourth exhaust flow path 834 and the lower-half valve communication hole 88. The second connection flow path 872 is formed such that a position of the fourth exhaust flow path 834 in the horizontal direction Dh matches with a position of the second connection flow path 872, when viewed from the axial direction Da. Therefore, the second connection flow path 872 is connected to the fourth exhaust flow path 834 by the lower-half valve casing 4B being combined with the upper-half valve casing 4A.

The lower-half valve communication hole 88 connects the lower-half main steam supply path 89 and the connection flow path 87. The lower-half valve communication hole 88 extends in the horizontal direction Dh to communicate with the outside of the lower-half valve casing 4B. The lower-half valve communication hole 88 extends in a linear shape in the horizontal direction Dh from a side surface of the lower-half valve casing 4B. That is, the lower-half valve communication hole 88 is open on the side surface of the lower-half valve casing 4B. In the present embodiment, as the lower-half valve communication hole 88, a plurality of lower-half valve communication holes 88 of a first lower-half valve communication hole 881 and a second lower-half valve communication hole 882 are provided.

The first lower-half valve communication hole 881 connects the side surface of the lower-half valve casing 4B to the first connection flow path 871 and the lower-half main steam supply path 89. The first lower-half valve communication hole 881 is formed at a position overlapping a lower end of the first connection flow path 871 in the vertical direction Dv, when viewed from the axial direction Da. Therefore, the first lower-half valve communication hole 881 communicates with the first exhaust flow path 831, via the first connection flow path 871. The first lower-half valve communication hole 881 extends linearly in the horizontal direction Dh from the side surface of the lower-half valve casing 4B to the lower-half main steam supply path 89, through the lower end of the first connection flow path 871.

The second lower-half valve communication hole 882 connects the side surface of the lower-half valve casing 4B to the second connection flow path 872 and the lower-half main steam supply path 89. The second lower-half valve communication hole 882 is formed on a side surface of an opposite side facing, in the horizontal direction Dh, a side opposite to a side surface on which the first lower-half valve communication hole 881 is formed. The second lower-half valve communication hole 882 is formed at a position overlapping a lower end of the second connection flow path 872 in the vertical direction Dv, when viewed from the axial direction Da. Therefore, the second lower-half valve communication hole 882 communicates with the fourth exhaust flow path 834, via the second connection flow path 872. The second lower-half valve communication hole 882 extends linearly in the horizontal direction Dh from the side surface of the lower-half valve casing 4B to the lower-half main steam supply path 89, through the lower end of the second connection flow path 872.

The lower-half main steam supply path 89 is capable of supplying, to the main steam flow path MP, the steam that has flowed through a part of the plurality of exhaust flow paths 83. The lower-half main steam supply path 89 is formed below the plurality of exhaust flow paths 83 in the vertical direction Dv. The lower-half main steam supply path 89 is curved and communicates with a part of the plurality of exhaust flow paths 83, via the lower-half valve communication hole 88. The lower-half main steam supply path 89 is formed in an arc shape to surround the rotary shaft insertion hole RH from below in the vertical direction Dv, when viewed from the axial direction Da. The lower-half main steam supply path 89 is located below the upper-half main steam supply path 86 in the vertical direction Dv. The lower-half main steam supply path 89 communicates with the outside of the lower-half valve casing 4B only on one side (the second side Da2) in the axial direction Da. The lower-half main steam supply path 89 is open on the same one side (the second side Da2) as the upper-half main steam supply path 86 in the axial direction Da. That is, the lower-half main steam supply path 89 is formed not to penetrate the lower-half valve casing 4B in the axial direction Da.

Further, the lower-half valve casing 4B has a lower-half outer-side inner peripheral surface 895 and a lower-half inner-side inner peripheral surface 897. The lower-half outer-side inner peripheral surface 895 is a curved surface on the outer-side Dro in the radial direction Dr, which faces the steam flowing in the lower-half main steam supply path 89. At least a part (lower end portion in the vertical direction Dv in the present embodiment) of the lower-half outer-side inner peripheral surface 895 in the lower-half main steam supply path 89 faces upward in the vertical direction Dv. The lower-half inner-side inner peripheral surface 897 is a curved surface on the inner-side Dri in the radial direction Dr facing the lower-half outer-side inner peripheral surface 895. At least a part (lower end portion in the vertical direction Dv in the present embodiment) of the lower-half inner-side inner peripheral surface 897 in the lower-half main steam supply path 89 faces downward in the vertical direction Dv. The lower-half inner-side inner peripheral surface 897 faces the steam flowing in the lower-half main steam supply path 89. That is, in the lower-half main steam supply path 89, the steam flows through a space between the lower-half outer-side inner peripheral surface 895 and the lower-half inner-side inner peripheral surface 897. In the present embodiment, as the lower-half main steam supply path 89, a plurality of lower-half main steam supply paths 89 of a first lower-half main steam supply path 891 communicating with the first exhaust flow path 831 and a second lower-half main steam supply path 892 communicating with the fourth exhaust flow path 834 are provided.

The first lower-half main steam supply path 891 is formed at a position close to the first inlet opening 821 with respect to the axis line O in the horizontal direction Dh, when viewed from the first side Dal in the axial direction Da. The first lower-half main steam supply path 891 is connected to the first lower-half valve communication hole 881 at an upper end in the vertical direction Dv. Accordingly, the first lower-half main steam supply path 891 communicates with the first exhaust flow path 831, via the first connection flow path 871 and the first lower-half valve communication hole 881. The first lower-half main steam supply path 891 extends in an arc shape to approach the second lower-half main steam supply path 892 downward in the vertical direction Dv from a position connected to the first lower-half valve communication hole 881.

The second lower-half main steam supply path 892 is formed at a position close to the second inlet opening 822 with respect to the axis line O in the horizontal direction Dh, when viewed from the first side Dal in the axial direction Da. The second lower-half main steam supply path 892 is formed to be separated from the first lower-half main steam supply path 891 in the horizontal direction Dh. The second lower-half main steam supply path 892 is connected to the second lower-half valve communication hole 882 at an upper end in the vertical direction Dv. Accordingly, the second lower-half main steam supply path 892 communicates with the fourth exhaust flow path 834, via the second connection flow path 872 and the second lower-half valve communication hole 882. The second lower-half main steam supply path 892 extends in an arc shape to approach the first lower-half main steam supply path 891 upward in the vertical direction Dv from a position connected to the second lower-half valve communication hole 882.

### Configuration of Casing Body

As shown in FIGS. 1 and 2, the casing body 5 is formed in a tubular shape extending in the axial direction Da. The casing body 5 covers the rotor 2 from the outer-side Dro in the radial direction Dr. The casing body 5 includes an upper-half body 5A and a lower-half body 5B.

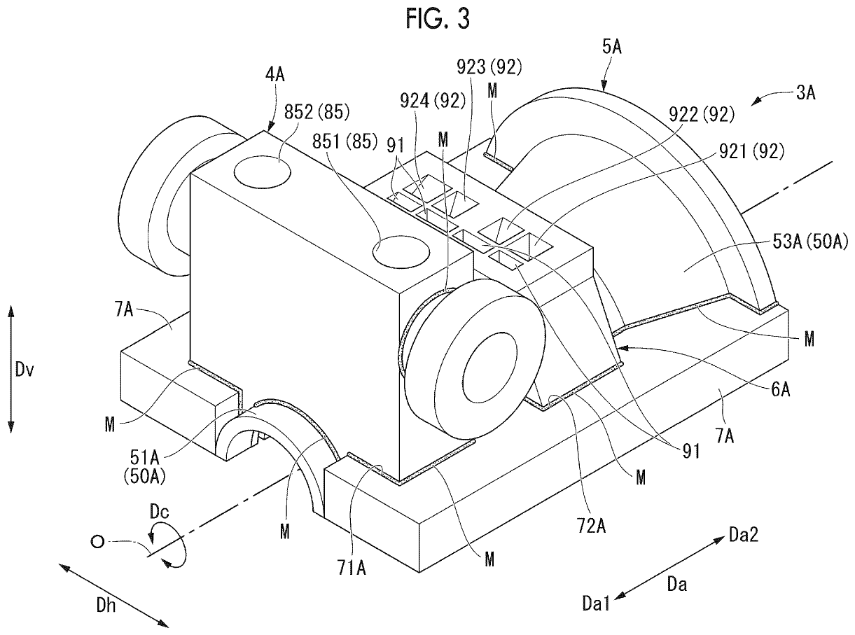

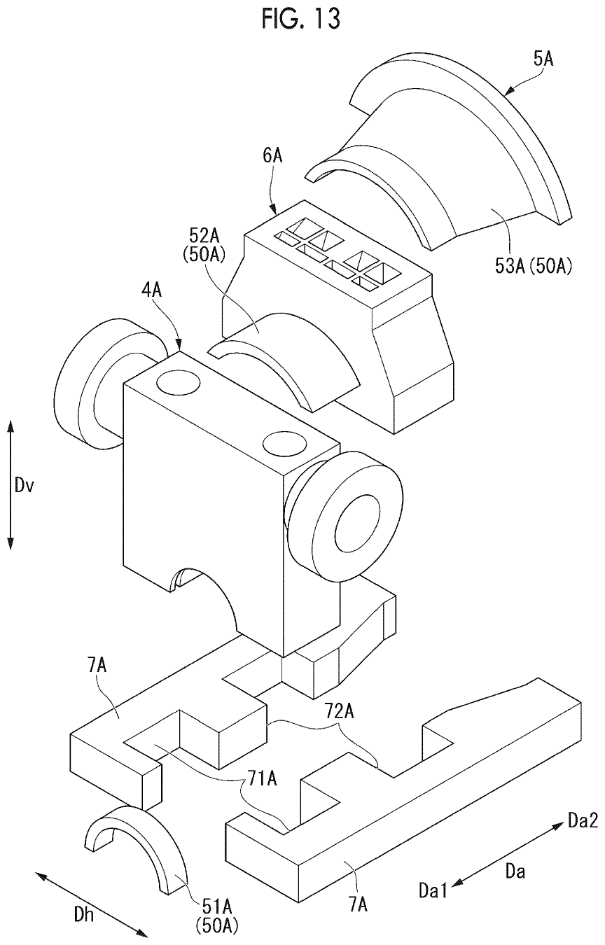

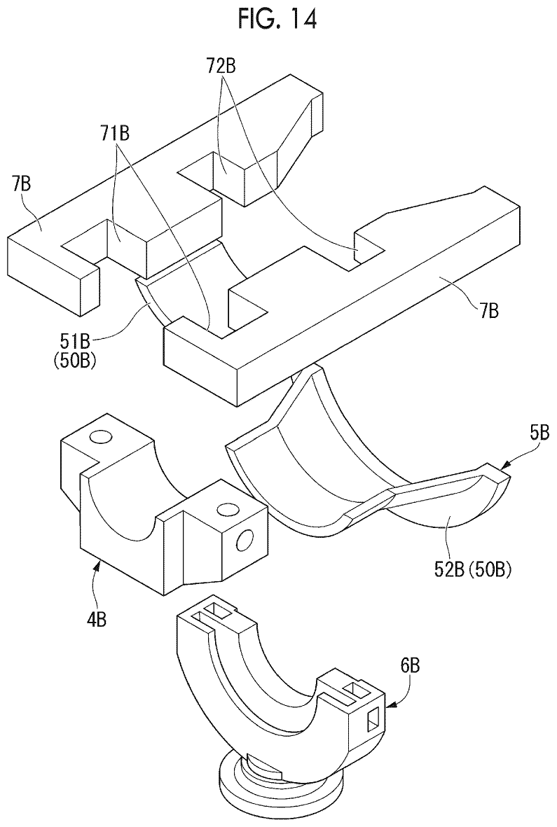

The upper-half body section 5A is disposed above in the vertical direction Dv with reference to the axis line O. As shown in FIG. 3, the upper-half body 5A is formed in a semi-tubular shape to have a cross-sectional semicircular shape open downward in the vertical direction Dv. In the present embodiment, the upper-half body 5A has a plurality of upper-half body block portions (body block portions) 50A (body block portions) arranged in the axial direction Da. Each of the upper-half body block portions 50A is formed by forging. Each of the upper-half body block portions 50A is not formed by joining a plurality of members by welding or the like, and is formed of only one forged member. In the present embodiment, the plurality of upper-half body block portions 50A have an upstream upper-half body block portion 51A, an intermediate upper-half body block portion 52A (refer to FIG. 13), and a downstream upper-half body block portion 53A. The upstream upper-half body block portion 51A is disposed on the first side Dal in the axial direction Da with respect to the upper-half valve casing 4A. The intermediate upper-half body block portion 52A is disposed between the upper-half valve casing 4A and an upper-half extraction valve casing 6A in the axial direction Da. The downstream upper-half body block portion 53A is disposed on the second side Da2 in the axial direction Da with respect to the upper-half extraction valve casing 6A.

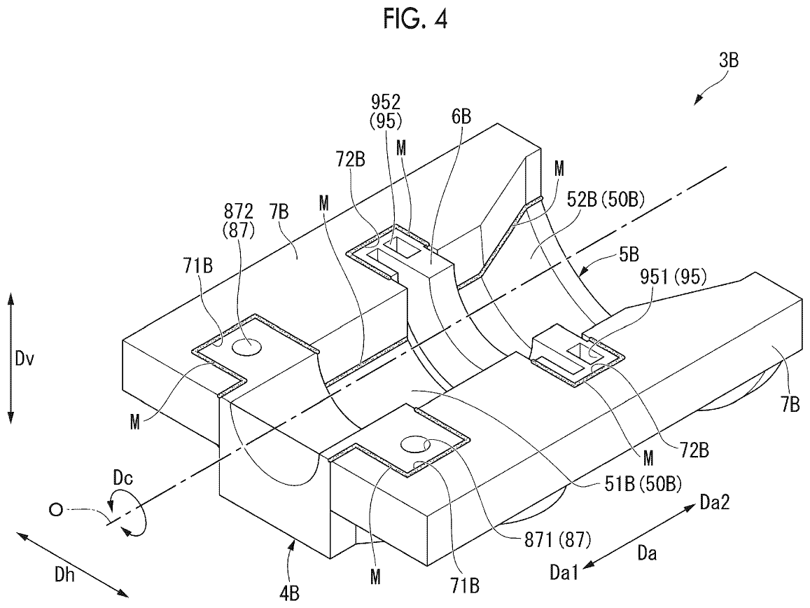

As shown in FIGS. 1 and 2, the lower-half body 5B is disposed below in the vertical direction Dv with reference to the axis line O. As shown in FIG. 4, the lower-half body 5B is formed in a semi-tubular shape to have a cross-sectional circular shape open upward in the vertical direction Dv. In the present embodiment, the lower-half body 5B has a plurality of lower-half body block portions (body block portions) 50B arranged in the axial direction Da. Each lower-half body block portion 50B is formed by forging. Each of the lower-half body block portions 50B is not formed by joining a plurality of members by welding or the like, and is formed of only one forged member. In the present embodiment, the plurality of lower-half body block portions 50B have an upstream lower-half body block portion 51B and a downstream lower-half body block portion 52B. The upstream lower-half body block portion 51B is disposed between the lower-half valve casing 4B and a lower-half extraction valve casing 6B in the axial direction Da. The downstream lower-half body block portion 52B is disposed on the second side Da2 in the axial direction Da with respect to the lower-half extraction valve casing 6B.

### Configuration of Extraction Valve Casing

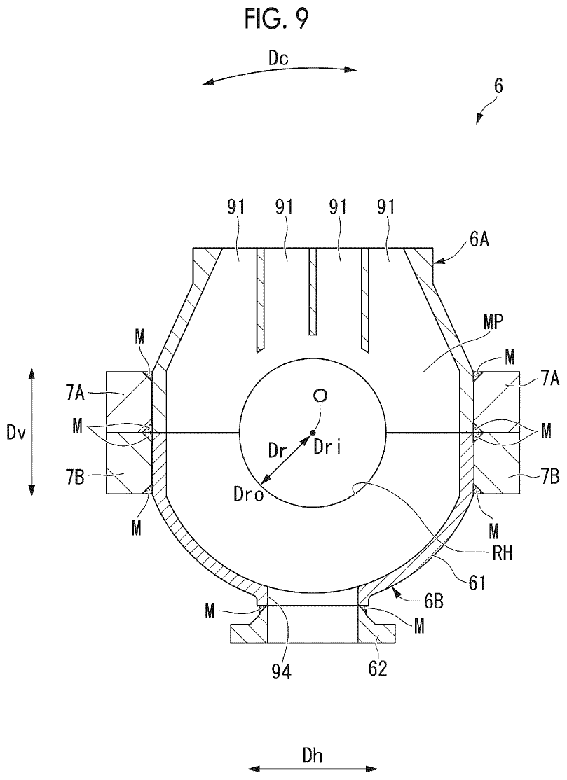

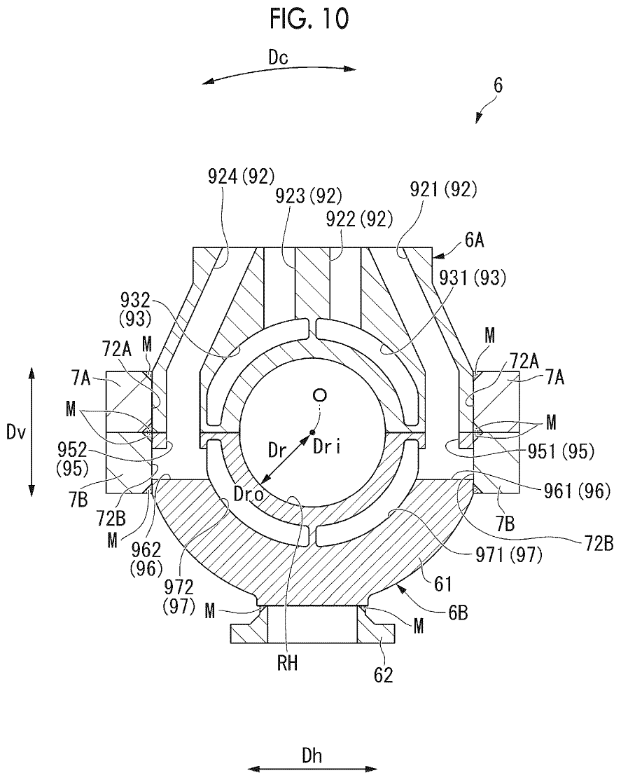

As shown in FIG. 1, the extraction valve casing 6 is disposed to be connected to the inside of the casing body 5 at an intermediate portion of the casing body 5 in the axial direction Da. In the extraction valve casing 6, the pressure of the steam that is once extracted to the outside from the inside of the casing body 5 and that flows into the inside of the casing body 5 again is adjusted. Further, in the extraction valve casing 6, a part of the steam in the casing body 5 is extracted to the outside. An extraction valve is connectable to the extraction valve casing 6. A space serving as a flow path through which the steam flows is formed inside the extraction valve casing 6. Further, as shown in FIGS. 9 and 10, a part of the rotary shaft insertion hole RH is formed inside the extraction valve casing 6 of the present embodiment. The extraction valve casing 6 has the upper-half extraction valve casing 6A above in the vertical direction Dv and the lower-half extraction valve casing 6B below in the vertical direction Dv. The extraction valve casing 6 can be divided into the upper-half extraction valve casing 6A and the lower-half extraction valve casing 6B with reference to the horizontal plane including the axis line O.

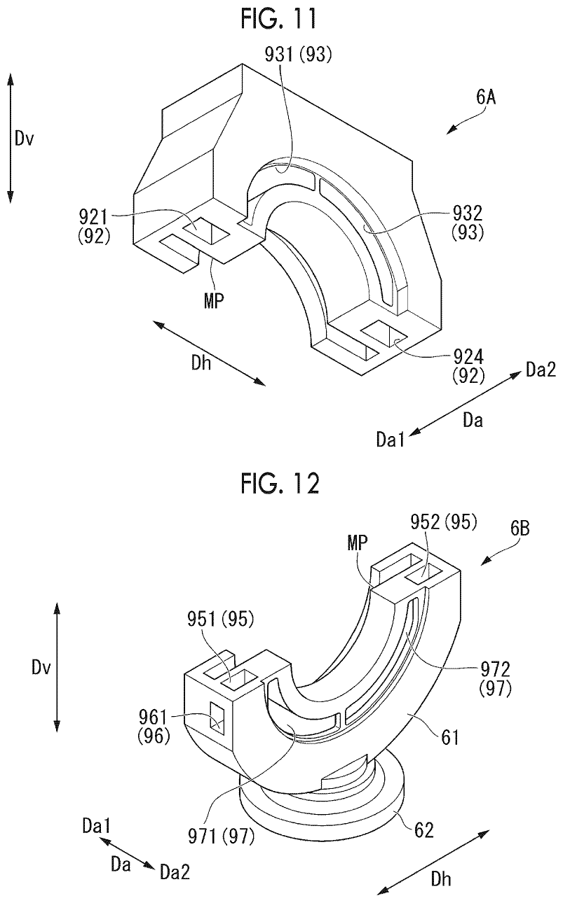

The upper-half extraction valve casing 6A is disposed above in the vertical direction Dv with reference to the axis line O. As shown in FIG. 11, the upper-half valve casing 4A is recessed upward in the vertical direction Dv when viewed from the axial direction Da to form an upper half of the rotary shaft insertion hole RH in the extraction valve casing 6. The upper-half extraction valve casing 6A is formed by forging. The upper-half extraction valve casing 6A is not formed by joining a plurality of members by welding or the like, and is formed of only one forged member. Further, as shown in FIGS. 9 and 10, an extraction inlet flow path 91, a plurality of extraction exhaust flow paths 92, and an upper-half extraction supply path 93 are provided inside the upper-half extraction valve casing 6A.

As shown in FIG. 9, the extraction inlet flow path 91 is a flow path into which the steam flowing from the main steam flow path MP flows. A plurality (four in the present embodiment) of extraction inlet flow paths 91 are formed to be arranged in the horizontal direction Dh. The extraction inlet flow path 91 extends downward in the vertical direction Dv from an upper surface of the upper-half extraction valve casing 6A (outer surface facing upward in the vertical direction Dv) to the main steam flow path MP. Lower ends of the plurality of extraction inlet flow paths 91 in the vertical direction Dv are connected to the main steam flow path MP to be merged. Upper ends of the plurality of extraction inlet flow paths 91 in the vertical direction Dv are disposed to be separated from each other in the horizontal direction Dh on the upper surface of the upper-half extraction valve casing 6A.

As shown in FIG. 10, the plurality of extraction exhaust flow paths 92 are flow paths into which the steam is extracted to the outside from the extraction inlet flow path 91 once and flows via the extraction valve. The plurality of extraction exhaust flow paths 92 are formed at positions separated from the extraction inlet flow path 91 in the axial direction Da. The plurality of extraction exhaust flow paths 92 are open at positions separated from each other in the horizontal direction Dh on the upper surface of the upper-half extraction valve casing 6A. The plurality of extraction exhaust flow paths 92 extend downward in the vertical direction Dv from the upper surface of the upper-half extraction valve casing 6A. In the present embodiment, the plurality (four in the present embodiment) of extraction exhaust flow paths 92 have, in order in the horizontal direction Dh, a first extraction exhaust flow path 921, a second extraction exhaust flow path 922, a third extraction exhaust flow path 923, and a fourth extraction exhaust flow path 924.

The first extraction exhaust flow path 921 and the fourth extraction exhaust flow path 924 are located on the outer-side Dro in the horizontal direction Dh, among the plurality of extraction exhaust flow paths 92. The first extraction exhaust flow path 921 and the fourth extraction exhaust flow path 924 connect the upper surface of the upper-half extraction valve casing 6A and a horizontal plane of the upper-half extraction valve casing 6A (outer surface facing downward in the vertical direction Dv, which comes into contact with the lower-half extraction valve casing 6B). The first extraction exhaust flow path 921 and the fourth extraction exhaust flow path 924 extend in a linear shape downward in the vertical direction Dv from the upper surface of the upper-half extraction valve casing 6A.

The second extraction exhaust flow path 922 and the third extraction exhaust flow path 923 are located to be interposed between the first extraction exhaust flow path 921 and the fourth extraction exhaust flow path 924 in the horizontal direction Dh. The second extraction exhaust flow path 922 is formed at a position closer to the first extraction exhaust flow path 921 than the fourth extraction exhaust flow path 924 in the horizontal direction Dh. The third extraction exhaust flow path 923 is formed at a position closer to the fourth extraction exhaust flow path 924 than the first extraction exhaust flow path 921 in the horizontal direction Dh. The second extraction exhaust flow path 922 and the third extraction exhaust flow path 923 connect the upper surface of the upper-half extraction valve casing 6A and the upper-half extraction supply path 93. The second extraction exhaust flow path 922 and the third extraction exhaust flow path 923 extend downward in the vertical direction Dv from the upper surface of the upper-half extraction valve casing 6A to be bent only once at an obtuse angle. The second extraction exhaust flow path 922 and the third extraction exhaust flow path 923 extend in a linear shape except for a bent portion.

The upper-half extraction supply path 93 is capable of supplying, to the main steam flow path MP, the steam that has flowed through a part of the plurality of extraction exhaust flow paths 92. The upper-half extraction supply path 93 is formed below the plurality of extraction exhaust flow paths 92 in the vertical direction Dv. The upper-half extraction supply path 93 is curved and communicates with a part of the plurality of extraction exhaust flow paths 92. The upper-half extraction supply path 93 is formed in an arc shape to surround the rotary shaft insertion hole RH from above in the vertical direction Dv, when viewed from the axial direction Da. As shown in FIGS. 10 and 11, the upper-half extraction supply path 93 communicates with the outside of the upper-half extraction valve casing 6A only on one side (the second side Da2) in the axial direction Da. That is, the upper-half extraction supply path 93 is formed not to penetrate the upper-half extraction valve casing 6A in the axial direction Da. In the present embodiment, as the upper-half extraction supply path 93, a plurality of upper-half extraction supply paths 93 of a first upper-half extraction supply path 931 connected to the second extraction exhaust flow path 922 and a second upper-half extraction supply path 932 connected to the third extraction exhaust flow path 923 are provided.

The first upper-half extraction supply path 931 is formed at a position close to the first extraction exhaust flow path 921 with respect to the axis line O in the horizontal direction Dh, when viewed from the first side Dal in the axial direction Da. The first upper-half extraction supply path 931 is connected to the second extraction exhaust flow path 922 at a lower end in the vertical direction Dv. The first upper-half extraction supply path 931 extends in an arc shape to approach the second upper-half extraction supply path 932 upward in the vertical direction Dv from a position connected to the second extraction exhaust flow path 922.

The second upper-half extraction supply path 932 is formed at a position close to the fourth extraction exhaust flow path 924 with respect to the axis line O in the horizontal direction Dh, when viewed from the first side Dal in the axial direction Da. The second upper-half extraction supply path 932 is formed to be separated from the first upper-half extraction supply path 931 in the horizontal direction Dh. The second upper-half extraction supply path 932 is connected to the third extraction exhaust flow path 923 at a lower end in the vertical direction Dv. The second upper-half extraction supply path 932 extends in an arc shape to approach the first upper-half extraction supply path 931 upward in the vertical direction Dv from a position connected to the third extraction exhaust flow path 923.

As shown in FIGS. 9 and 10, the lower-half extraction valve casing 6B is disposed below in the vertical direction Dv with reference to the axis line O. The lower-half extraction valve casing 6B is recessed downward in the vertical direction Dv when viewed from the axial direction Da to form a lower-half of the rotary shaft insertion hole RH in the extraction valve casing 6. Further, an extraction discharge flow path 94, an extraction connection flow path 95, a lower-half extraction valve communication hole 96, and a lower-half extraction supply path 97 are provided inside the lower-half extraction valve casing 6B.

As shown in FIG. 9, the extraction discharge flow path 94 is a flow path that extracts the steam flowing from the main steam flow path MP in the middle of the steam turbine 1 and discharges the steam to the outside. The extraction discharge flow path 94 extends downward in the vertical direction Dv from a part of the main steam flow path MP formed in the lower-half extraction valve casing 6B to a bottom surface (outer surface facing downward in the vertical direction Dv) of the lower-half extraction valve casing 6B. An upper end of the extraction discharge flow path 94 in the vertical direction Dv is connected to the main steam flow path MP. A lower end of the extraction discharge flow path 94 in the vertical direction Dv communicates with the outside at the bottom surface of the lower-half extraction valve casing 6B.

As shown in FIGS. 10 and 12, the extraction connection flow path 95 is capable of supplying, to the lower-half extraction valve communication hole 96, the steam that has flowed through the first extraction exhaust flow path 921 and the fourth extraction exhaust flow path 924. The extraction connection flow path 95 connects a horizontal plane of the lower-half extraction valve casing 6B (outer surface facing upward in the vertical direction Dv, which comes into contact with the upper-half extraction valve casing 6A) and the lower-half extraction valve communication hole 96. The extraction connection flow path 95 extends in a linear shape downward in the vertical direction Dv from the horizontal plane of the lower-half extraction valve casing 6B. The extraction connection flow path 95 extends perpendicularly to the horizontal plane of the lower-half extraction valve casing 6B. In the present embodiment, as the extraction connection flow path 95, a plurality of extraction connection flow paths 95 of a first extraction connection flow path 951 and a second extraction connection flow path 952 are provided.

The first extraction connection flow path 951 connects the first extraction exhaust flow path 921 and the lower-half extraction valve communication hole 96. The first extraction connection flow path 951 is formed such that a position of the first extraction exhaust flow path 921 in the horizontal direction Dh matches with a position of the first extraction connection flow path 951, when viewed from the axial direction Da. Therefore, the first extraction connection flow path 951 is connected to the first extraction exhaust flow path 921 by the lower-half extraction valve casing 6B being combined with the upper-half extraction valve casing 6A.

The second extraction connection flow path 952 connects the fourth extraction exhaust flow path 924 and the lower-half extraction valve communication hole 96. The second extraction connection flow path 952 is formed such that a position of the second extraction connection flow path 952 in the horizontal direction Dh matches with a position of the fourth extraction exhaust flow path 924, when viewed from the axial direction Da. Therefore, the second extraction connection flow path 952 is connected to the fourth extraction exhaust flow path 924 by the lower-half extraction valve casing 6B being combined with the upper-half extraction valve casing 6A.

The plurality of lower-half extraction valve communication holes 96 connect the lower-half extraction supply path 97 and the extraction connection flow path 95. The plurality of lower-half extraction valve communication holes 96 extend in the horizontal direction Dh to communicate with the outside of the lower-half extraction valve casing 6B. The plurality of lower-half extraction valve communication holes 96 extend in a linear shape in the horizontal direction Dh from a side surface of the lower-half extraction valve casing 6B. That is, the lower-half extraction valve communication hole 96 is open on the side surface of the lower-half extraction valve casing 6B. In the present embodiment, the plurality of lower-half extraction valve communication holes 96 have a first lower-half extraction valve communication hole 961 and a second lower-half extraction valve communication hole 962.

The first lower-half extraction valve communication hole 961 connects the side surface of the lower-half extraction valve casing 6B to the first extraction connection flow path 951 and the lower-half extraction supply path 97. The first lower-half extraction valve communication hole 961 is formed at a position overlapping a lower end of the first extraction connection flow path 951 in the vertical direction Dv, when viewed from the axial direction Da. Therefore, the first lower-half extraction valve communication hole 961 communicates with the first extraction exhaust flow path 921, via the first extraction connection flow path 951. The first lower-half extraction valve communication hole 961 extends linearly in the horizontal direction Dh from the side surface of the lower-half extraction valve casing 6B to the lower-half extraction supply path 97, through the lower end of the first extraction connection flow path 951.

The second lower-half extraction valve communication hole 962 connects the side surface of the lower-half extraction valve casing 6B to the second extraction connection flow path 952 and the lower-half extraction supply path 97. The second lower-half extraction valve communication hole 962 is formed on a side surface of an opposite side facing, in the horizontal direction Dh, a side opposite to a side surface on which the first lower-half extraction valve communication hole 961 is formed. The second lower-half extraction valve communication hole 962 is formed at a position overlapping a lower end of the second extraction connection flow path 952 in the vertical direction Dv, when viewed from the axial direction Da. Therefore, the second lower-half extraction valve communication hole 962 communicates with the fourth extraction exhaust flow path 924, via the second extraction connection flow path 952. The second lower-half extraction valve communication hole 962 extends linearly in the horizontal direction Dh from the side surface of the lower-half extraction valve casing 6B to the lower-half extraction supply path 97, through the lower end of the second extraction connection flow path 952.

The lower-half extraction supply path 97 is capable of supplying, to the main steam flow path MP, the steam that has flowed through a part of the plurality of extraction exhaust flow paths 92. The lower-half extraction supply path 97 is formed below the plurality of extraction exhaust flow paths 92 in the vertical direction Dv. The lower-half extraction supply path 97 is curved and communicates with a part of the plurality of exhaust flow paths 83, via the lower-half extraction valve communication hole 96. The lower-half extraction supply path 97 is formed in an arc shape to surround the rotary shaft insertion hole RH from below in the vertical direction Dv, when viewed from the axial direction Da. The lower-half extraction supply path 97 is located below the upper-half extraction supply path 93 in the vertical direction Dv. The lower-half extraction supply path 97 communicates with the outside of the lower-half extraction valve casing 6B only on one side (the second side Da2) in the axial direction Da. The lower-half extraction supply path 97 is open on the same one side (the second side Da2) as the upper-half extraction supply path 93 in the axial direction Da. That is, the lower-half extraction supply path 97 is formed not to penetrate the lower-half valve casing 4B in the axial direction Da. Further, in the present embodiment, as the lower-half extraction supply path 97, a plurality of lower-half extraction supply paths 97 of a first lower-half extraction supply path 971 communicating with the first extraction exhaust flow path 921 and a second lower-half extraction supply path 972 communicating with the fourth extraction exhaust flow path 924 are provided.

The first lower-half extraction supply path 971 is formed at a position close to the first extraction exhaust flow path 921 with respect to the axis line O in the horizontal direction Dh, when viewed from the first side Dal in the axial direction Da. The first lower-half extraction supply path 971 is connected to the first lower-half extraction valve communication hole 961 at an upper end in the vertical direction Dv. Accordingly, the first lower-half extraction supply path 971 communicates with the first extraction exhaust flow path 921, via the first extraction connection flow path 951 and the first lower-half extraction valve communication hole 961. The first lower-half extraction supply path 971 extends in an arc shape to approach the second lower-half extraction supply path 972 downward in the vertical direction Dv from a position connected to the first lower-half extraction valve communication hole 961.

The second lower-half extraction supply path 972 is formed at a position close to the fourth extraction exhaust flow path 924 with respect to the axis line O in the horizontal direction Dh, when viewed from the first side Dal in the axial direction Da. The second lower-half extraction supply path 972 is formed to be separated from the first lower-half extraction supply path 971 in the horizontal direction Dh. The second lower-half extraction supply path 972 is connected to the second lower-half extraction valve communication hole 962 at an upper end in the vertical direction Dv. Accordingly, the second lower-half extraction supply path 972 communicates with the fourth extraction exhaust flow path 924, via the second extraction connection flow path 952 and the second lower-half extraction valve communication hole 962. The second lower-half extraction supply path 972 extends in an arc shape to approach the first lower-half extraction supply path 971 upward in the vertical direction Dv from a position connected to the second lower-half extraction valve communication hole 962.

Further, the lower-half extraction valve casing 6B is formed by joining a plurality of members by welding. The lower-half extraction valve casing 6B of the present embodiment has a lower-half extraction valve casing main body 61 and an extraction discharge nozzle 62. That is, the lower-half extraction valve casing 6B further has the welding portion M that fixes the lower-half extraction valve casing main body 61 and the extraction discharge nozzle 62 to each other by welding.

The lower-half extraction valve casing main body 61 is formed by forging. The lower-half extraction valve casing main body 61 is not formed by joining a plurality of members by welding or the like, and is formed of only one forged member. The extraction discharge flow path 94, the plurality of extraction connection flow paths 95, the plurality of lower-half extraction supply paths 97, and the plurality of lower-half extraction valve communication holes 96 are formed inside the lower-half extraction valve casing main body 61.

The extraction discharge nozzle 62 is formed by forging. The extraction discharge nozzle 62 is not formed by joining a plurality of members by welding or the like, and is formed of only one forged member. The extraction discharge nozzle 62 is formed in a cylindrical shape. The extraction discharge nozzle 62 is disposed adjacent to and below the lower-half extraction valve casing main body 61 in the vertical direction Dv. The extraction discharge nozzle 62 is welded to the lower-half extraction valve casing main body 61 in a state where an opening thereof faces a bottom surface of the lower-half extraction valve casing main body 61 to form the extraction discharge flow path 94, together with the lower-half extraction valve casing main body 61. Therefore, the welding portion M is formed between the extraction discharge nozzle 62 and the lower-half extraction valve casing main body 61.

### Configuration of Upper-Half Flange

As shown in FIG. 3, the pair of upper-half flanges 7A is disposed at both end portions of the upper-half body 5A in the circumferential direction De around the axis line O. The pair of upper-half flanges 7A extends in the axial direction Da. The pair of upper-half flanges 7A is connected to the upper-half valve casing 4A, the upper-half body 5A, and the upper-half extraction valve casing 6A by welding. The pair of upper-half flanges 7A of the present embodiment is formed in a symmetrical shape with the axis line O as a boundary. Each of the upper-half flanges 7A is a block-shaped member that is long in the axial direction Da, which extends from the upstream upper-half body block portion 51A to the downstream upper-half body block portion 53A in the axial direction Da. As shown in FIGS. 3 and 13, each of the upper-half flanges 7A is formed with a first upper-half groove 71A and a second upper-half groove 72A.

The first upper-half groove 71A is a groove into which the upper-half valve casing 4A is fitted. The first upper-half groove 71A is formed to be recessed in the horizontal direction Dh at a position overlapping the upper-half valve casing 4A in the axial direction Da. The first upper-half groove 71A is formed in a size that allows a side portion of the upper-half valve casing main body 41 to be inserted into the groove.

The second upper-half groove 72A is a groove into which the upper-half extraction valve casing 6A is fitted. The second upper-half groove 72A is disposed to be separated from the first upper-half groove 71A in the axial direction Da. The second upper-half groove 72A is formed to be recessed in the horizontal direction Dh at a position overlapping the upper-half extraction valve casing 6A in the axial direction Da. The second upper-half groove 72A is formed in a size that allows a side portion of the upper-half extraction valve casing 6A to be inserted into the groove.

### Configuration of Lower-Half Flange

As shown in FIG. 4, the pair of lower-half flanges 7B is disposed at both end portions of the lower-half body 5B in the circumferential direction Dc around the axis line O. The pair of lower-half flanges 7B extends in the axial direction Da. The pair of lower-half flanges 7B are connected to the lower-half valve casing 4B, the lower-half body 5B, and the lower-half extraction valve casing 6B by welding. The pair of lower-half flanges 7B of the present embodiment is formed in a symmetrical shape with the axis line O as a boundary. Each lower-half flange 7B is a block-shaped member that is long in the axial direction Da, which extends from the upstream lower-half body block portion 51B to the downstream lower-half body block portion 52B in the axial direction Da. As shown in FIGS. 4 and 14, each of the lower-half flanges 7B is formed with a first lower-half groove 71B and a second lower-half groove 72B.

The first lower-half groove 71B is a groove into which the lower-half valve casing 4B is fitted. The first lower-half groove 71B is formed to be recessed in the horizontal direction Dh at a position overlapping the lower-half valve casing 4B in the axial direction Da. The first lower-half groove 71B is formed in a size that allows a side portion of the lower-half valve casing 4B to be inserted into the groove. As shown in FIG. 5, with a state of the side portion of the lower-half valve casing 4B being inserted into the first lower-half groove 71B, the lower-half flange 7B is disposed at a position overlapping the lower-half valve communication hole 88 in the vertical direction Dv. That is, with the state of the side portion of the lower-half valve casing 4B being inserted into the first lower-half groove 71B, the lower-half flange 7B is disposed to close the lower-half valve communication hole 88, when viewed from the axial direction Da.

As shown in FIGS. 4 and 14, the second lower-half groove 72B is a groove into which the lower-half extraction valve casing 6B is fitted. The second lower-half groove 72B is disposed to be separated from the first lower-half groove 71B in the axial direction Da. The second lower-half groove 72B is formed to be recessed in the horizontal direction Dh at a position overlapping the lower-half extraction valve casing 6B in the axial direction Da. The second lower-half groove 72B is formed in a size that allows a side portion of the lower-half extraction valve casing main body 61 to be inserted into the groove. As shown in FIG. 10, with a state of the side portion of the lower-half extraction valve casing main body 61 being inserted into the second lower-half groove 72B, the lower-half flange 7B is disposed at a position overlapping the lower-half extraction valve communication hole 96 in the vertical direction Dv. That is, with the state of the side portion of the lower-half extraction valve casing main body 61 being inserted into the second lower-half groove 72B, the lower-half flange 7B is disposed to close the lower-half extraction valve communication hole 96, when viewed from the axial direction Da.

As shown in FIGS. 3 and 13, the upper-half valve casing 4A, the upper-half body 5A, the upper-half extraction valve casing 6A, and the pair of upper-half flanges 7A are integrated with each other by being welded to each other in a manufacturing stage, and thus the upper-half casing 3A is formed. Therefore, the welding portions M are respectively formed between the upper-half valve casing 4A, the upper-half body 5A, the upper-half extraction valve casing 6A, and the pair of upper-half flanges 7A. Further, as shown in FIGS. 4 and 14, the lower-half valve casing 4B, the lower-half body 5B, the lower-half extraction valve casing 6B, and the pair of lower-half flanges 7B are integrated by being welded to each other in a manufacturing stage, and thus the lower-half casing 3B is formed. The welding portions M are respectively formed between the lower-half valve casing 4B, the lower-half body 5B, the lower-half extraction valve casing 6B, and the pair of lower-half flanges 7B.

### Procedure of Method for Manufacturing Casing

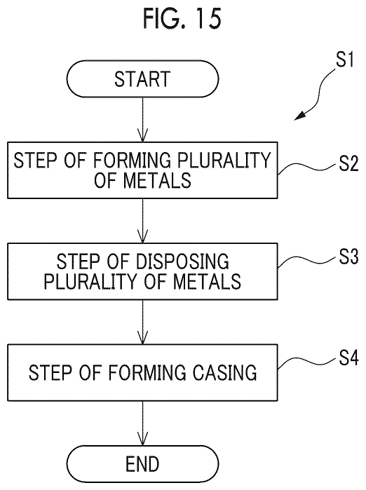

As shown in FIG. 15, in a method S1 for manufacturing the casing, the upper-half casing 3A and the lower-half casing 3B are respectively manufactured. The method S1 for manufacturing the casing has step S2 of forming a plurality of metals, step S3 of disposing the plurality of metals, and step S4 of forming the casing.

### Step of Forming Plurality of Metals

In step S2 of forming a plurality of metals, the plurality of metals serving as components configuring the casing 3 are formed. In the present embodiment, the plurality of metals have a plurality of metals forming the upper-half casing 3A and a plurality of metals forming the lower-half casing 3B. The plurality of metals forming the upper-half casing 3A are the upper-half valve casing 4A, the upstream upper-half body block portion 51A, the intermediate upper-half body block portion 52A, the downstream upper-half body block portion 53A, the upper-half extraction valve casing 6A, and the pair of upper-half flanges 7A, as shown in FIG. 13. The plurality of metals forming the lower-half casing 3B are the lower-half valve casing 4B, the upstream lower-half body block portion 51B, the downstream lower-half body block portion 52B, the lower-half extraction valve casing 6B, and the pair of lower-half flanges 7B, as shown in FIG. 14. In the step of forming the metals, the plurality of metals are manufactured by forging. That is, all the metals are manufactured by one type of manufacturing method of casting. A space (flow path or the like) inside one forged member manufactured by forging is cut by machining to form the plurality of metals.

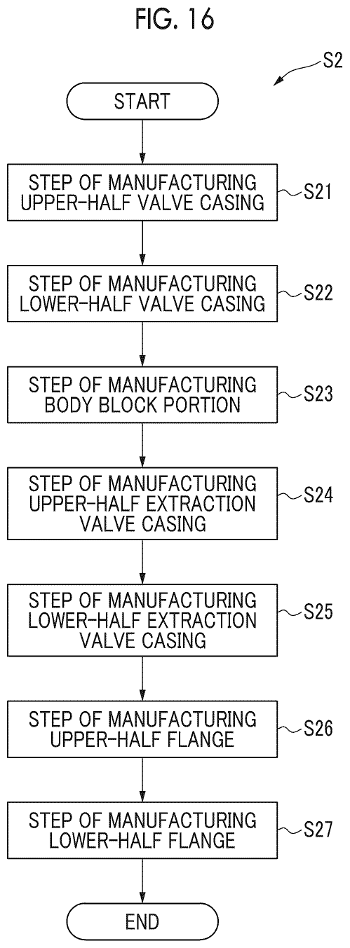

As shown in FIG. 16, step S2 of forming the plurality of metals of the present embodiment has step S21 of manufacturing the upper-half valve casing, step S22 of manufacturing the lower-half valve casing, step S23 of manufacturing the body block portion, step S24 of manufacturing the upper-half extraction valve casing, step S25 of manufacturing the lower-half extraction valve casing, step S26 of manufacturing the upper-half flange, and step S27 of manufacturing the lower-half flange. An order in which the above steps are implemented may be any order, and any one or all of the steps may be implemented at the same time.

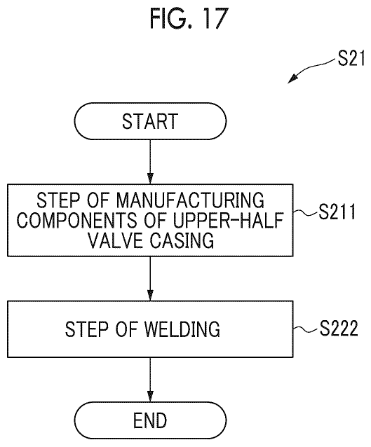

As shown in FIG. 17, step S21 of manufacturing the upper-half valve casing has step S221 of manufacturing components of the upper-half valve casing and step S222 of welding.

In step S221 of manufacturing components of the upper-half valve casing, components configuring the upper-half valve casing 4A are manufactured separately. Specifically, in the present embodiment, the upper-half valve casing main body 41, the first upper-half closing member 421, the second upper-half closing member 422, the first upper-half inlet nozzle 431, and the second upper-half inlet nozzle 432 are separately manufactured.

For example, the upper-half valve casing main body 41 is formed as a solid forged member having a smooth outer shape by forging. Thereafter, the inside of one forged member serving as a base of the upper-half valve casing main body 41 is cut to manufacture the upper-half valve casing main body 41. For example, the inlet flow path 81 and the inlet opening 82 are obtained by forming, by milling or the like, a through-hole linearly in the horizontal direction Dh, in one forged member. Further, the plurality of exhaust flow paths 83 are obtained by forming, by milling or the like, through-holes linearly in the vertical direction Dv, from a bottom surface far from the inlet flow path 81 to the inlet flow path 81 in the vertical direction Dv, in one forged member. The member insertion hole 85 is obtained by forming, by milling or the like, a through-hole linearly in the vertical direction Dv, from an upper surface close to the inlet flow path 81 to the inlet flow path 81 in the vertical direction Dv, in one forged member. The upper-half main steam supply path 86 is obtained by cutting, by milling or the like, a surface of one forged member, which is far from the inlet flow path 81 in the vertical direction Dv, to form the curved upper-half outer-side inner peripheral surface 865. With the formation of the plurality of flow paths or surfaces in the solid forged member in this manner, the upper-half valve casing main body 41 is manufactured.

The first upper-half closing member 421 and the second upper-half closing member 422 are respectively formed as one forged member having a smooth outer shape by forging. Thereafter, each forged member is cut by milling or the like to form the curved upper-half inner-side inner peripheral surface 867, and thus the first upper-half closing member 421 and the second upper-half closing member 422 are obtained, respectively.

The first upper-half inlet nozzle 431 and the second upper-half inlet nozzle 432 are respectively formed as one forged member having a smooth outer shape by forging. Thereafter, a through-hole is formed, by milling or the like, linearly inside each forged member to obtain the first upper-half inlet nozzle 431 and the second upper-half inlet nozzle 432.

In step S222 of welding, the upper-half valve casing main body 41, the upper-half closing member 42, and the upper-half inlet nozzle 43 are fixed by welding. Accordingly, the welding portion M is formed between the upper-half valve casing main body 41, the upper-half closing member 42, and the upper-half inlet nozzle 43, and the upper-half valve casing 4A, which is one metal, is formed.

In step S22 of manufacturing the lower-half valve casing, a solid forged member having a smooth outer shape by forging is formed. Thereafter, the inside of one forged member serving as a base of the lower-half valve casing 4B is cut to manufacture the lower-half valve casing 4B. For example, the lower-half main steam supply path 89 is obtained by cutting, by milling or the like, a surface of one forged member, which faces the second side Da2 in the axial direction Da, such that the surface thereof is not penetrated. The lower-half valve communication hole 88 is obtained by forming, by milling or the like, a through-hole linearly from a side surface facing the horizontal direction Dh to the lower-half main steam supply path 89, in one forged member. Further, the connection flow path 87 is obtained by forming, by milling or the like, a through-hole linearly from an upper surface in the vertical direction Dv to the lower-half valve communication hole 88, in one forged member. With the formation of the plurality of flow paths or surfaces in the solid forged member in this manner, the lower-half valve casing 4B is manufactured.

In step S23 of manufacturing the body block portion, the upstream upper-half body block portion 51A, the intermediate upper-half body block portion 52A, the downstream upper-half body block portion 53A, the upstream lower-half body block portion 51B, and the downstream lower-half body block portion 52B are manufactured. The upstream upper-half body block portion 51A, the intermediate upper-half body block portion 52A, the downstream upper-half body block portion 53A, the upstream lower-half body block portion 51B, and the downstream lower-half body block portion 52B are formed by forging, respectively. The upstream upper-half body block portion 51A, the intermediate upper-half body block portion 52A, the downstream upper-half body block portion 53A, the upstream lower-half body block portion 51B, and the downstream lower-half body block portion 52B may be formed only by forging, and may be additionally processed by milling or the like to smooth a surface that is a part of the main steam flow path MP.

In step S24 of manufacturing the upper-half extraction valve casing, a solid forged member having a smooth outer shape by forging is formed. Thereafter, the inside of one forged member serving as a base of the upper-half extraction valve casing 6A is cut to manufacture the upper-half extraction valve casing 6A. Therefore, the plurality of extraction inlet flow paths 91 are obtained by forming, by milling or the like, through-holes linearly in the vertical direction Dv from an upper surface in the vertical direction Dv. The first extraction exhaust flow path 921 and the fourth extraction exhaust flow path 924 are obtained by forming, by milling or the like, a hole linearly in the vertical direction Dv from each of an upper surface and a bottom surface in the vertical direction Dv. The upper-half extraction supply path 93 is obtained by cutting, by milling or the like, a surface of one forged member, which faces the second side Da2 in the axial direction Da, such that the surface thereof is not penetrated. The second extraction exhaust flow path 922 and the third extraction exhaust flow path 923, and the plurality of extraction inlet flow paths 91 are obtained by forming, by milling or the like, through-holes linearly in the vertical direction Dv from an upper surface in the vertical direction Dv to the upper-half extraction supply path 93. With the formation of the plurality of flow paths or surfaces in the solid forged member in this manner, the upper-half extraction valve casing 6A is manufactured.

In step S25 of manufacturing the lower-half extraction valve casing, components configuring the lower-half extraction valve casing 6B are manufactured separately. Specifically, the lower-half extraction valve casing main body 61 and the extraction discharge nozzle 62 are separately manufactured by forging. The lower-half extraction valve casing main body 61 is formed as a solid forged member having a smooth outer shape by forging. Thereafter, the inside of one forged member serving as a base of the lower-half extraction valve casing main body 61 is cut to manufacture the lower-half extraction valve casing main body 61. For example, the extraction discharge flow path 94 is obtained by forming, by milling or the like, a hole linearly in the vertical direction Dv from a bottom surface in the vertical direction Dv to the main steam flow path MP, in one forged member. The lower-half extraction supply path 97 is obtained by cutting, by milling or the like, a surface of one forged member, which faces the second side Da2 in the axial direction Da, such that the surface thereof is not penetrated. The lower-half extraction valve communication hole 96 is obtained by forming, by milling or the like, a through-hole linearly from a side surface facing the horizontal direction Dh to the lower-half extraction supply path 97, in one forged member. Further, the extraction connection flow path 95 is obtained by forming, by milling or the like, a through-hole linearly from an upper surface in the vertical direction Dv to the lower-half extraction valve communication hole 96, in one forged member. With the formation of the plurality of flow paths or surfaces in the solid forged member in this manner, the lower-half extraction valve casing 6B is manufactured.

The extraction discharge nozzles 62 are respectively formed as one forged member having a smooth outer shape by forging. Thereafter, a through-hole is formed, by milling or the like, linearly inside each forged member to obtain the extraction discharge nozzle 62. Thereafter, the lower-half extraction valve casing main body 61 and the extraction discharge nozzle 62 are fixed by welding. Accordingly, the welding portion M is formed between the lower-half extraction valve casing main body 61 and the extraction discharge nozzle 62, and the lower-half extraction valve casing 6B, which is one metal, is formed.

In step S26 of manufacturing the upper-half flange, the pair of upper-half flanges 7A is formed by forging. In step S27 of manufacturing the lower-half flange, the pair of upper-half flanges 7A is formed by forging. The upper-half flange 7A and the lower-half flange 7B may be formed only by forging, and may be additionally processed, by milling or the like, to smooth a surface for forming a groove.

### Step of Disposing Plurality of Metals

In step S3 of disposing the plurality of metals, the plurality of metals are disposed in accordance with the casing 3 required to be formed. That is, as shown in FIG. 13, the upper-half valve casing 4A, the upstream upper-half body block portion 51A, the intermediate upper-half body block portion 52A, the downstream upper-half body block portion 53A, the upper-half extraction valve casing 6A, and the pair of upper-half flanges 7A that configure the upper-half casing 3A are disposed to abut against each other. Further, as shown in FIG. 14, the lower-half valve casing 4B, the upstream lower-half body block portion 51B, the downstream lower-half body block portion 52B, the lower-half extraction valve casing 6B, and the pair of lower-half flanges 7B, which configure the lower-half casing 3B, are disposed to abut against each other.

### Step of Forming Casing

In step S4 of forming the casing, a plurality of metals are welded to each other to form the casing 3. That is, the upstream upper-half body block portion 51A, the intermediate upper-half body block portion 52A, the downstream upper-half body block portion 53A, the inlet valve casing 4, the upper-half extraction valve casing 6A, and the pair of upper-half flanges 7A, which abut against each other, are integrally joined by welding. Accordingly, the welding portion M is formed between the upstream upper-half body block portion 51A, the intermediate upper-half body block portion 52A, the downstream upper-half body block portion 53A, the inlet valve casing 4, the upper-half extraction valve casing 6A, and the pair of upper-half flanges 7A, respectively. Further, the upstream lower-half body block portion 51B, the downstream lower-half body block portion 52B, the lower-half extraction valve casing 6B, and the pair of lower-half flanges 7B, which abut against each other, are integrally joined by welding. Accordingly, the welding portion M is formed between the upstream lower-half body block portion 51B, the downstream lower-half body block portion 52B, the lower-half extraction valve casing 6B, and the pair of lower-half flanges 7B, respectively.

In step S3 of disposing the plurality of metals and step S4 of forming the casing, an operation of disposing two metals adjacent to each other to abut against each other and then welding both metals together may be sequentially repeated.

### Effects

With the casing 3 of the steam turbine 1 having the above configuration, the inlet flow path 81, the inlet opening 82, the exhaust flow path 83, the member insertion hole 85, and the upper-half main steam supply path 86 are formed inside the upper-half valve casing 4A. Further, the first exhaust flow path 831 and the second exhaust flow path 832 are disposed at positions where at least a part of the first exhaust flow path 831 and the second exhaust flow path 832 is separated from the first member insertion hole 851, when viewed from the vertical direction Dv. Furthermore, the third exhaust flow path 833 and the fourth exhaust flow path 834 are disposed at positions where at least a part of the third exhaust flow path 833 and the fourth exhaust flow path 834 is separated from the second member insertion hole 852, when viewed from the vertical direction Dv. That is, the plurality of exhaust flow paths 83 and the member insertion hole 85 are disposed in a complex manner such that the plurality of exhaust flow paths 83 and the member insertion hole 85 cannot be formed at the same time from the same side in the vertical direction Dv. Further, the first upper-half main steam supply path 861 communicating with the second exhaust flow path 832 and the second upper-half main steam supply path 862 communicating with the third exhaust flow path 833 not only have a curved shape, but also have a structure in which the first upper-half main steam supply path 861 and the second upper-half main steam supply path 862 communicate with the outside of the upper-half valve casing 4A only on the second side Da2 in the axial direction Da. That is, in the vertical direction Dv, one end portion of the second exhaust flow path 832 and the third exhaust flow path 833 is blocked by the first member insertion hole 851 and the second member insertion hole 852, and the other end portion of the second exhaust flow path 832 and the third exhaust flow path 833 is blocked by the first upper-half main steam supply path 861 and the second upper-half main steam supply path 862. Therefore, the second exhaust flow path 832 and the third exhaust flow path 833 are formed at positions where the second exhaust flow path 832 and the third exhaust flow path 833 cannot be directly processed from the vertical direction Dv. For this reason, in general, a member in which such a complex flow path is formed inside needs to be formed by casting. However, in the present embodiment, the first upper-half main steam supply path 861 and the second upper-half main steam supply path 862 are formed by fixing the first upper-half closing member 421 and the second upper-half closing member 422, which are disposed below the upper-half valve casing main body 41 in the vertical direction Dv, to the upper-half valve casing main body 41 by welding. The second exhaust flow path 832 and the third exhaust flow path 833 are formed in the upper-half valve casing main body 41. That is, before the first upper-half closing member 421 and the second upper-half closing member 422 are attached, the second exhaust flow path 832 and the third exhaust flow path 833 are in a state of being open below the upper-half valve casing main body 41 in the vertical direction Dv. Thus, with machining on the upper-half valve casing main body 41 from below in the vertical direction Dv, it is possible to easily form, from the outside, the second exhaust flow path 832 and the third exhaust flow path 833. Accordingly, it is possible to form, from the outside, the second exhaust flow path 832 and the third exhaust flow path 833 in the upper-half valve casing main body 41, which is a single component, with high accuracy. Further, the inlet flow path 81, the first inlet opening 821, the second inlet opening 822, the first member insertion hole 851, the second member insertion hole 852, the first exhaust flow path 831, and the second exhaust flow path 832, which communicate with the outside, are also formed in the upper-half valve casing main body 41. Thus, with machining on the upper-half valve casing main body 41, it is possible to easily form, from the outside, the inlet flow path 81, the first inlet opening 821, the second inlet opening 822, the first member insertion hole 851, the second member insertion hole 852, the first exhaust flow path 831, and the second exhaust flow path 832. Accordingly, it is possible to form, from the outside, the inlet flow path 81, the first inlet opening 821, the second inlet opening 822, the first member insertion hole 851, the second member insertion hole 852, the first exhaust flow path 831, and the second exhaust flow path 832 in the upper-half valve casing main body 41, which is a single component, with high accuracy. Accordingly, it is possible to form a plurality of flow paths inside the upper-half valve casing 4A without using casting.

Further, the inlet flow path 81, the plurality of inlet openings 82, the plurality of member insertion holes 85, and the plurality of exhaust flow paths 83 are not formed by the joining of a plurality of members by welding or the like, and are formed in the upper-half valve casing main body 41 formed of only one forged member formed by forging. A region where the regulating valve, which is an inlet of the steam, is disposed, is exposed to the steam having the highest pressure, in the steam turbine 1. That is, the steam having the highest pressure flows through the inlet flow path 81, the plurality of inlet openings 82, the plurality of member insertion holes 85, and the plurality of exhaust flow paths 83, in the steam turbine 1. With the formation of the flow path through which the high-pressure steam flows in the upper-half valve casing main body 41, which is a single component, it is possible to ensure sufficient pressure resistance while having a simple structure.

Further, the upper-half outer-side inner peripheral surface 865 is formed in the upper-half valve casing main body 41, and the upper-half inner-side inner peripheral surface 867 is formed in the first upper-half closing member 421 and the second upper-half closing member 422. Therefore, the inner peripheral surfaces of the first upper-half main steam supply path 861 and the second upper-half main steam supply path 862 are formed in a separate member. In particular, the upper-half outer-side inner peripheral surface 865 is formed as an outer surface in the upper-half valve casing main body 41. Similarly, the upper-half inner-side inner peripheral surface 867 is also formed as an outer surface in the first upper-half closing member 421 and the second upper-half closing member 422. Thus, it is possible to easily form, from the outside of the member, the upper-half outer-side inner peripheral surface 865 and the upper-half inner-side inner peripheral surface 867. Accordingly, it is possible to form the upper-half main steam supply path 86 with high accuracy in the upper-half valve casing 4A.

Further, the upper-half valve casing main body 41, the plurality of upper-half closing members 42, the plurality of upper-half inlet nozzles 43, the lower-half valve casing 4B, the plurality of upper-half body block portions 50A, the plurality of lower-half body block portions 50B, the upper-half extraction valve casing 6A, the lower-half extraction valve casing main body 61, the extraction discharge nozzle 62, the pair of upper-half flanges 7A, and the pair of lower-half flanges 7B are all formed by forging. Further, the flow path of each component is formed by cutting one forged member formed by forging. That is, it is possible to form most of the components configuring the casing 3 by forging, not by casting.

Further, the first lower-half valve communication hole 881 and the second lower-half valve communication hole 882, which are formed in the lower-half valve casing 4B, extend from the side surface of the lower-half valve casing 4B. That is, it is possible to easily form the first lower-half valve communication hole 881 and the second lower-half valve communication hole 882, from the outside of the lower-half valve casing 4B. Furthermore, the openings of the first lower-half valve communication hole 881 and the second lower-half valve communication hole 882, which are formed on the side surface of the lower-half valve casing 4B, are closed by the pair of lower-half flanges 7B. Thus, with the formation of the lower-half casing 3B by attachment of the lower-half flange 7B, the first lower-half valve communication hole 881 and the second lower-half valve communication hole 882, which are open on the side surface of the lower-half valve casing 4B, become flow paths closed from the outside. That is, it is possible to use the lower-half flange 7B as a part of the surface on which the first lower-half valve communication hole 881 and the second lower-half valve communication hole 882 are formed. Accordingly, it is possible to form the lower-half valve communication hole 88 with high accuracy substantially inside the lower-half valve casing 4B.

Further, the extraction inlet flow path 91, the first extraction exhaust flow path 921, the second extraction exhaust flow path 922, the third extraction exhaust flow path 923, and the first extraction exhaust flow path 921 are formed inside the upper-half extraction valve casing 6A in a state of being open on the upper surface of the upper-half extraction valve casing 6A. Thus, with machining on the upper-half extraction valve casing 6A from above in the vertical direction Dv, it is possible to easily form, from the outside, the extraction inlet flow path 91, the first extraction exhaust flow path 921, the second extraction exhaust flow path 922, the third extraction exhaust flow path 923, and the fourth extraction exhaust flow path 924. Accordingly, it is possible to form, from the outside, the extraction inlet flow path 91, the first extraction exhaust flow path 921, the second extraction exhaust flow path 922, the third extraction exhaust flow path 923, and the first extraction exhaust flow path 921 in the upper-half extraction valve casing 6A, which is a single component, with high accuracy. Furthermore, the first upper-half extraction supply path 931 communicating with the second extraction exhaust flow path 922 and the second upper-half extraction supply path 932 communicating with the third extraction exhaust flow path 923 not only have a curved shape, but also have a structure in which the first upper-half extraction supply path 931 and the second upper-half extraction supply path 932 communicate with the outside of the extraction valve casing 6 only on the second side Da2 in the axial direction Da. Thus, with machining on the upper-half extraction valve casing 6A from the second side Da2 in the axial direction Da, it is possible to easily form, from the outside, the first upper-half extraction supply path 931 and the second upper-half extraction supply path 932. Accordingly, it is possible to form, from the outside, the upper-half extraction supply path 93 with high accuracy in the upper-half extraction valve casing 6A, which is a single component, with high accuracy. Accordingly, it is possible to form a plurality of flow paths inside the upper-half extraction valve casing 6A without using casting.

Further, the first lower-half extraction valve communication hole 961 and the second lower-half extraction valve communication hole 962, which are formed in the lower-half extraction valve casing 6B, extend from the side surface of the lower-half extraction valve casing 6B. That is, it is possible to easily form the first lower-half extraction valve communication hole 961 and the second lower-half extraction valve communication hole 962, from the outside of the lower-half extraction valve casing 6B. Furthermore, the openings of the first lower-half valve communication hole 881 and the second lower-half valve communication hole 882, which are formed on the side surface of the lower-half valve casing 4B, are closed by the pair of lower-half flanges 7B. Thus, with the formation of the lower-half casing 3B by attachment of the lower-half flange 7B, the first lower-half valve communication hole 881 and the second lower-half valve communication hole 882, which are open on the side surface of the lower-half valve casing 4B, become flow paths closed from the outside. That is, it is possible to use the lower-half flange 7B as a part of the surface on which the first lower-half valve communication hole 881 and the second lower-half valve communication hole 882 are formed. Accordingly, it is possible to form the lower-half valve communication hole 88 with high accuracy substantially inside the lower-half valve casing 4B.

### Other Embodiments

Although the embodiment of the present disclosure has been described in detail with reference to the drawings, the specific configuration is not limited to the embodiment and includes a design change and the like within a range not departing from the gist of the present disclosure.

The casing 3 of the present embodiment has the structure including the inlet valve casing 4, the casing body 5, the extraction valve casing 6, the pair of upper-half flanges 7A, and the pair of lower-half flanges 7B. However, the casing 3 is not limited to such a structure. For example, the casing 3 may not have the extraction valve casing 6. Further, the casing 3 may have a structure other than the structure described in the above embodiment.

Further, the upper-half valve casing 4A is not limited to the structure in which only the inlet flow path 81, the inlet opening 82, the plurality of exhaust flow paths 83, the member insertion hole 85, and the upper-half main steam supply path 86 are included inside the upper-half valve casing 4A. A hole for inserting another flow path or a member may be formed inside the upper-half valve casing 4A. Further, the number of the inlet flow paths 81, the inlet openings 82, the exhaust flow paths 83, the member insertion holes 85, and the upper-half main steam supply paths 86, which are included in the upper-half valve casing 4A, is not limited to the number of the above embodiment.

Further, the upper-half valve casing 4A is not limited to the structure including only the upper-half valve casing main body 41, the upper-half closing member 42, the upper-half inlet nozzle 43, and the welding portion M, as in the above embodiment. The upper-half valve casing 4A may have another member.

Further, the lower-half valve casing 4B is not limited to the structure in which only the connection flow path 87, the lower-half valve communication hole 88, and the lower-half main steam supply path 89 are included inside the lower-half valve casing 4B. A hole for inserting another flow path or a member may be formed inside the lower-half valve casing 4B. Further, the number of the connection flow paths 87, the lower-half valve communication holes 88, and the lower-half main steam supply paths 89, which are included in the lower-half valve casing 4B, is not limited to the number of the above embodiment.

Further, the lower-half valve casing 4B is not limited to the structure formed of only one forged member, as in the above embodiment. The upper-half valve casing 4A may have another member.

Further, the upper-half body 5A is not limited to the structure including only the upstream upper-half body block portion 51A, the intermediate upper-half body block portion 52A, and the downstream upper-half body block portion 53A, as in the above embodiment. The upper-half body 5A may further have another upper-half body block portion 50A or another member. Further, the number of the upper-half body block portions 50A may be three or less.

Further, the lower-half body 5B is not limited to the structure including only the upstream lower-half body block portion 51B and the downstream lower-half body block portion 52B, as in the above embodiment. The lower-half body 5B may further have another lower-half body block portion 50B or another member. Further, the number of the lower-half body block portions 50B may be only one.

Further, the upper-half extraction valve casing 6A is not limited to the structure in which only the extraction inlet flow path 91, the plurality of extraction exhaust flow paths 92, and the upper-half extraction supply path 93 are included inside the upper-half extraction valve casing 6A. A hole for inserting another flow path or a member may be formed inside the upper-half extraction valve casing 6A. Further, the number of the extraction inlet flow paths 91, the number of the extraction exhaust flow paths 92, and the number of the upper-half extraction supply paths 93, which are included in the upper-half extraction valve casing 6A, is not limited to the number of the above embodiment.

Further, the lower-half extraction valve casing 6B is not limited to the structure in which only the extraction discharge flow path 94, the extraction connection flow path 95, the lower-half extraction valve communication hole 96, and the lower-half extraction supply path 97 are included inside the lower-half extraction valve casing 6B. A hole for inserting another flow path or a member may be formed inside the lower-half extraction valve casing 6B. Further, the number of the extraction discharge flow paths 94, the extraction connection flow paths 95, the lower-half extraction valve communication holes 96, and the lower-half extraction supply paths 97, which are included in the lower-half extraction valve casing 6B, is not limited to the number of the above embodiment.

Further, the pair of upper-half flanges 7A or the pair of lower-half flanges 7B may have the same shape or may have completely different shapes.

### Additional Notes

The casing 3 and the method S1 for manufacturing the casing according to the embodiment are understood as follows, for example.

(1) A casing 3 according to a first aspect has a valve casing of a regulating valve in which an upper-half valve casing 4A above in a vertical direction Dv and a lower-half valve casing 4B below in the vertical direction Dv are included and a supply amount of steam to be supplied in a steam turbine 1 is adjustable, a casing body 5 that has an upper-half body 5A above in the vertical direction Dv and a lower-half body 5B below in the vertical direction Dv, is formed in a tubular shape centered on an axis line O extending in an axial direction Da, and is connected to the valve casing, a pair of upper-half flanges 7A that is connected to the upper-half valve casing 4A and the upper-half body 5A at both end portions in a circumferential direction De around the axis line O with respect to the upper-half body 5A, and extends in the axial direction Da, and a pair of lower-half flanges 7B that is connected to the lower-half valve casing 4B and the lower-half body 5B at both end portions in the circumferential direction Dc with respect to the lower-half body 5B, and extends in the axial direction Da, in which the upper-half body 5A and the lower-half body 5B each have a plurality of body block portions arranged in the axial direction Da, the upper-half valve casing 4A has an inlet flow path 81 that allows a valve body 11 to be disposed and is formed in a linear shape in a first direction orthogonal to the vertical direction Dv and the axial direction Da, an inlet opening 82 that allows a fluid to flow into the inlet flow path 81 and causes an end portion of the inlet flow path 81 in the first direction to communicate with an outside, a plurality of exhaust flow paths 83 that communicate with the inlet flow path 81 at positions separated from each other in the first direction such that the fluid in the inlet flow path 81 is caused to flow out in the vertical direction Dv, a member insertion hole 85 that causes the inlet flow path to communicate 81 with the outside at a position facing the plurality of exhaust flow paths 83 in the vertical direction Dv, and an upper-half main steam supply path 86 that is curved and communicates with a part of the plurality of exhaust flow paths 83, the lower-half valve casing 4B has a lower-half main steam supply path 89 that is curved and communicates with a remaining part of the plurality of exhaust flow paths 83, at least a part of the plurality of exhaust flow paths 83 is disposed at a position separated from the member insertion hole 85 when viewed from the vertical direction Dv, the upper-half main steam supply path 86 and the lower-half main steam supply path 89 communicate with an outside of the upper-half valve casing 4A and the lower-half valve casing 4B only on one side in the axial direction Da, and the upper-half valve casing 4A has an upper-half valve casing main body 41 in which the inlet flow path 81, the inlet opening 82, the exhaust flow path 83, and the member insertion hole 85 are formed, an upper-half closing member 42 that is disposed below the upper-half valve casing main body 41 in the vertical direction Dv to form, together with the upper-half valve casing main body 41, the upper-half main steam supply path 86, and a welding portion M that fixes the upper-half valve casing main body 41 and the upper-half closing member 42 to each other by welding.

Accordingly, the upper-half main steam supply path 86 is formed by fixing the upper-half closing member 42, which is disposed below the upper-half valve casing main body 41 in the vertical direction Dv, to the upper-half valve casing main body 41 by welding. A part of the plurality of exhaust flow paths 83 is formed in the upper-half valve casing main body 41. That is, before the upper-half closing member 42 is attached, a part of the plurality of exhaust flow paths 83 is in a state of being open below the upper-half valve casing main body 41 in the vertical direction Dv. Thus, with the machining on the upper-half valve casing main body 41 from below in the vertical direction Dv, it is possible to easily form, from the outside, a part of the plurality of exhaust flow paths 83. Accordingly, it is possible to form, from the outside, a part of the plurality of exhaust flow paths 83 in the upper-half valve casing main body 41, which is a single component, with high accuracy. Further, the inlet flow path 81, the inlet opening 82, the member insertion hole 85, and a remaining part of the plurality of exhaust flow paths 83, which communicate with the outside, are also formed in the upper-half valve casing main body 41. Thus, with the machining on the upper-half valve casing main body 41, it is possible to easily form, from the outside, the inlet flow path 81, the inlet opening 82, the member insertion hole 85, and the remaining part of the plurality of exhaust flow paths 83. Accordingly, it is possible to form, from the outside, the inlet flow path 81, the inlet opening 82, the member insertion hole 85, and the remaining part of the plurality of exhaust flow paths 83 in the upper-half valve casing main body 41, which is a single component, with high accuracy. Accordingly, it is possible to form a plurality of flow paths inside the upper-half valve casing 4A without using casting.

(2) The casing 3 according to a second aspect is the casing 3 of (1), in which the upper-half main steam supply path 86 is formed in an arc shape when viewed from the axial direction Da, the upper-half valve casing main body 41 has an outer-side Dro inner peripheral surface having at least a part of the outer-side inner peripheral surface that faces downward in the vertical direction Dv in the upper-half main steam supply path 86, and the upper-half closing member 42 has an inner-side Dri inner peripheral surface having at least a part of the inner-side inner peripheral surface that faces upward in the vertical direction Dv in the upper-half main steam supply path 86.

Accordingly, the inner peripheral surface of the upper-half main steam supply path 86 is formed in a separate member. In particular, the outer-side Dro inner peripheral surface in the upper-half valve casing main body 41 is formed as an outer surface. Similarly, the inner-side Dri inner peripheral surface in the upper-half closing member 42 is also formed as an outer surface. Thus, it is possible to easily form, from the outside of the member, the outer-side Dro inner peripheral surface and the inner-side Dri inner peripheral surface. Accordingly, it is possible to form the upper-half main steam supply path 86 with high accuracy in the upper-half valve casing 4A.

(3) The casing 3 according to a third aspect is the casing 3 of (1) or (2), in which the upper-half valve casing main body 41, the upper-half closing member 42, the body block portion, the upper-half flange 7A, and the lower-half flange 7B are formed by forging.

Accordingly, it is possible to form most of the components configuring the casing 3 by forging, not by casting.

(4) The casing 3 according to a fourth aspect is the casing 3 of any one of (1) to (3), in which the lower-half valve casing 4B has a lower-half valve communication hole 88 that is connected to the lower-half main steam supply path 89 and extends in the first direction to communicate with the outside, and the lower-half flange 7B is disposed to close the lower-half valve communication hole 88 when viewed from the first direction.

Accordingly, it is possible to easily form the lower-half valve communication hole 88, from the outside of the lower-half valve casing 4B. Further, the opening of the lower-half valve communication hole 88 formed on the side surface of the lower-half valve casing 4B is closed by the pair of lower-half flanges 7B. Thus, with the attachment of the lower-half flange 7B, the lower-half valve communication hole 88, which is open on the side surface of the lower-half valve casing 4B, becomes a flow path closed from the outside. That is, it is possible to use the lower-half flange 7B as a part of the surface on which the lower-half valve communication hole 88 is formed. Accordingly, it is possible to form the lower-half valve communication hole 88 with high accuracy substantially inside the lower-half valve casing 4B.

(5) The casing 3 according to a fifth aspect is the casing 3 of any one of (1) to (4), and further includes an extraction valve casing 6 that is connected to the casing body 5, the upper-half flange 7A, and the lower-half flange 7B at a position separated from the valve casing in the axial direction Da, and communicates with an inside of the casing body 5, in which the extraction valve casing 6 has an upper-half extraction valve casing 6A having an upper surface that faces upward in the vertical direction Dv, an extraction inlet flow path 91 that is open at a position separated from the upper surface in the first direction, a plurality of extraction exhaust flow paths 92 that are open at positions separated from the extraction inlet flow path 91 in the axial direction Da and at the positions separated from each other on the upper surface in the first direction, and an upper-half extraction supply path 93 that is curved and communicates with a part of the plurality of extraction exhaust flow paths 92, and a lower-half extraction valve casing 6B disposed below the upper-half extraction valve casing 6A in the vertical direction Dv and having a lower-half extraction supply path 97 that is curved and communicates with a remaining part of the plurality of extraction exhaust flow paths 92, and the upper-half extraction supply path 93 communicates with an outside of the upper-half extraction valve casing 6A only on one side in the axial direction Da.

Accordingly, with the machining on the upper-half extraction valve casing 6A from above in the vertical direction Dv, it is possible to easily form, from the outside, the extraction inlet flow path 91, the extraction exhaust flow path 92, the second extraction exhaust flow path 922, the third extraction exhaust flow path 923, and the fourth extraction exhaust flow path 924. Accordingly, it is possible to form, from the outside, the extraction inlet flow path 91 and the plurality of extraction exhaust flow paths 92 in the upper-half extraction valve casing 6A, which is a single component, with high accuracy. Further, the upper-half extraction supply path 93, which communicates with a part of the plurality of extraction exhaust flow paths 92, not only has a curved shape, but also has a structure in which the upper-half extraction supply path 93 communicates with the outside of the extraction valve casing 6 only on the second side Da2 in the axial direction Da. Thus, with the machining on the upper-half extraction valve casing 6A from the second side Da2 in the axial direction Da, it is possible to easily form, from the outside, the upper-half extraction supply path 93. Accordingly, it is possible to form, from the outside, the upper-half extraction supply path 93 with high accuracy in the upper-half extraction valve casing 6A, which is a single component, with high accuracy. Accordingly, it is possible to form a plurality of flow paths inside the upper-half extraction valve casing 6A without using casting.

(6) The casing 3 according to a sixth aspect is the casing 3 of (5), in which the lower-half extraction valve casing 6B has a lower-half extraction valve communication hole 96 that is connected to the lower-half extraction supply path 97 and extends in the first direction to communicate with an outside of the extraction valve casing 6, and the lower-half flange 7B is disposed to close the lower-half extraction valve communication hole 96 when viewed from the first direction.

Accordingly, it is possible to easily form the lower-half extraction valve communication hole 96, from the outside of the lower-half extraction valve casing 6B. Further, the opening of the lower-half valve communication hole 88 formed on the side surface of the lower-half valve casing 4B is closed by the pair of lower-half flanges 7B. Thus, with the formation of the lower-half casing 3B by attachment of the lower-half flange 7B, the lower-half valve communication hole 88, which is open on the side surface of the lower-half valve casing 4B, becomes a flow path closed from the outside. That is, it is possible to use the lower-half flange 7B as a part of the surface on which the lower-half valve communication hole 88 is formed. Accordingly, it is possible to form the lower-half valve communication hole 88 with high accuracy substantially inside the lower-half valve casing 4B.

(7) A method S1 for manufacturing a casing according to a seventh aspect includes a valve casing of a regulating valve in which an upper-half valve casing 4A above in a vertical direction Dv and a lower-half valve casing 4B below in the vertical direction Dv are included and a supply amount of steam to be supplied in a steam turbine 1 is adjustable, a casing body 5 that has an upper-half body 5A above in the vertical direction Dv and a lower-half body 5B below in the vertical direction Dv, is formed in a tubular shape centered on an axis line O extending in an axial direction Da, and is connected to the valve casing, a pair of upper-half flanges 7A that is connected to the upper-half valve casing 4A and the upper-half body 5A at both end portions in a circumferential direction De around the axis line O with respect to the upper-half body 5A, and extends in the axial direction Da, and a pair of lower-half flanges 7B that is connected to the lower-half valve casing 4B and the lower-half body 5B at both end portions in the circumferential direction De with respect to the lower-half body 5B, and extends in the axial direction Da, in which the upper-half body 5A and the lower-half body 5B each have a plurality of body block portions arranged in the axial direction Da, the upper-half valve casing 4A has an inlet flow path 81 that allows a valve body 11 to be disposed and is formed in a linear shape in a first direction orthogonal to the vertical direction Dv and the axial direction Da, an inlet opening 82 that allows a fluid to flow into the inlet flow path 81 and causes an end portion of the inlet flow path 81 in the first direction to communicate with an outside, a plurality of exhaust flow paths 83 that communicate with the inlet flow path 81 at positions separated from each other in the first direction such that the fluid in the inlet flow path 81 is caused to flow out in the vertical direction Dv, a member insertion hole 85 that causes the inlet flow path to communicate 81 with the outside at a position facing the plurality of exhaust flow paths 83 in the vertical direction Dv, and an upper-half main steam supply path 86 that is curved and communicates with a part of the plurality of exhaust flow paths 83, the lower-half valve casing 4B has a lower-half main steam supply path 89 that is curved and communicates with a remaining part of the plurality of exhaust flow paths 83, at least a part of the plurality of exhaust flow paths 83 is disposed at a position separated from the member insertion hole 85 when viewed from the vertical direction Dv, the upper-half main steam supply path 86 and the lower-half main steam supply path 89 communicate with an outside of the upper-half valve casing 4A and the lower-half valve casing 4B only on one side in the axial direction Da, and the upper-half valve casing 4A has an upper-half valve casing main body 41 in which the inlet flow path 81, the inlet opening 82, the exhaust flow path 83, and the member insertion hole 85 are formed, an upper-half closing member 42 that is disposed below the upper-half valve casing main body 41 in the vertical direction Dv to form, together with the upper-half valve casing main body 41, the upper-half main steam supply path 86, and a welding portion M that fixes the upper-half valve casing main body 41 and the upper-half closing member 42 to each other by welding. The manufacturing method S1 includes a step of manufacturing the upper-half valve casing main body 41 and the upper-half closing member 42, and a step S222 of welding the upper-half valve casing main body 41 and the upper-half closing member 42 to each other, in which in the step of manufacturing, one forged member formed by forging is cut to manufacture the upper-half valve casing main body 41 and the upper-half closing member 42.

### Industrial Applicability

According to the casing and the method for manufacturing a casing of the present disclosure, it is possible to form the plurality of flow paths inside the casing without using casting.

### REFERENCE SIGNS LIST

1: steam turbine
2: rotor
21: rotary shaft
22: rotor blade
O: axis line
23A: first bearing
23B: second bearing
3: casing
3A: upper-half casing
3B: lower-half casing
315A: upper-half diaphragm
315B: lower-half diaphragm
317: stator vane
MP: main steam flow path
RH: rotary shaft insertion hole
4: inlet valve casing
4A: upper-half valve casing
81: inlet flow path
82: inlet opening
821: first inlet opening
822: second inlet opening
83: exhaust flow path
831: first exhaust flow path
832: second exhaust flow path
833: third exhaust flow path
834: fourth exhaust flow path
83a: small-diameter flow path
83b: large-diameter flow path
85: member insertion hole
851: first member insertion hole
852: second member insertion hole
86: upper-half main steam supply path
865: upper-half outer-side inner peripheral surface
867: upper-half inner-side inner peripheral surface
861: first upper-half main steam supply path
862: second upper-half main steam supply path
41: upper-half valve casing main body
42: upper-half closing member
421: first upper-half closing member
422: second upper-half closing member
43: upper-half inlet nozzle
431: first upper-half inlet nozzle
432: second upper-half inlet nozzle
4B: lower-half valve casing
87: connection flow path
871: first connection flow path
872: second connection flow path
88: lower-half valve communication hole
881: first lower-half valve communication hole
882: second lower-half valve communication hole
89: lower-half main steam supply path
895: lower-half outer-side inner peripheral surface
897: lower-half inner-side inner peripheral surface
891: first lower-half main steam supply path
892: second lower-half main steam supply path
11: valve body
12: inner bar
13: rod
5: casing body
5A: upper-half body
50A: upper-half body block portion
51A: upstream upper-half body block portion
52A: intermediate upper-half body block portion
53A: downstream upper-half body block portion
5B: lower-half body
50B: lower-half body block portion
51B: upstream lower-half body block portion
52B: downstream lower-half body block portion
6: extraction valve casing
6A: upper-half extraction valve casing
91: extraction inlet flow path
92: extraction exhaust flow path
921: first extraction exhaust flow path
922: second extraction exhaust flow path
923: third extraction exhaust flow path
924: fourth extraction exhaust flow path
93: upper-half extraction supply path
931: first upper-half extraction supply path
932: second upper-half extraction supply path
6B: lower-half extraction valve casing
94: extraction discharge flow path
95: extraction connection flow path
951: first extraction connection flow path
952: second extraction connection flow path
96: lower-half extraction valve communication hole
961: first lower-half extraction valve communication hole
962: second lower-half extraction valve communication hole
97: lower-half extraction supply path
971: first lower-half extraction supply path
972: second lower-half extraction supply path
61: lower-half extraction valve casing main body
62: extraction discharge nozzle
7A: upper-half flange
71A: first upper-half groove
72A: second upper-half groove
7B: lower-half flange
71B: first lower-half groove
72B: second lower-half groove
M: welding portion
Da: axial direction
Da1: first side
Da2: second side
Dr: radial direction
Dro: outer-side
Dri: inner-side
Dv: vertical direction
Dh: horizontal direction
Dc: circumferential direction
S1: method for manufacturing casing
S2: step of forming plurality of metals
S21: step of manufacturing upper-half valve casing
S221: step of manufacturing component of upper-half valve casing
S222: step of welding
S22: step of manufacturing lower-half valve casing
S23: step of manufacturing body block
S24: step of manufacturing upper-half extraction valve casing
S25: step of manufacturing lower-half extraction valve casing
S26: step of manufacturing upper-half flange
S27: step of manufacturing lower-half flange
S3: step of disposing a plurality of metals
S4: step of forming casing

1. A casing comprising:
a valve casing of a regulating valve in which an upper-half valve casing above in a vertical direction and a lower-half valve casing below in the vertical direction are included and a supply amount of steam to be supplied in a steam turbine is adjustable;
a casing body that has an upper-half body above in the vertical direction and a lower-half body below in the vertical direction, is formed in a tubular shape centered on an axis line extending in an axial direction, and is connected to the valve casing;
a pair of upper-half flanges that is connected to the upper-half valve casing and the upper-half body at both end portions in a circumferential direction around the axis line with respect to the upper-half body, and extends in the axial direction; and
a pair of lower-half flanges that is connected to the lower-half valve casing and the lower-half body at both end portions in the circumferential direction with respect to the lower-half body, and extends in the axial direction, wherein
the upper-half body and the lower-half body each have a plurality of body block portions arranged in the axial direction,
the upper-half valve casing has
an inlet flow path that allows a valve body to be disposed and is formed in a linear shape in a first direction orthogonal to the vertical direction and the axial direction,
an inlet opening that allows a fluid to flow into the inlet flow path and causes an end portion of the inlet flow path in the first direction to communicate with an outside,
a plurality of exhaust flow paths that communicate with the inlet flow path at positions separated from each other in the first direction such that the fluid in the inlet flow path is caused to flow out in the vertical direction,
a member insertion hole that causes the inlet flow path to communicate with the outside at a position facing the plurality of exhaust flow paths in the vertical direction, and
an upper-half main steam supply path that is curved and communicates with a part of the plurality of exhaust flow paths,
the lower-half valve casing has a lower-half main steam supply path that is curved and communicates with a remaining part of the plurality of exhaust flow paths,
at least a part of the plurality of exhaust flow paths is disposed at a position separated from the member insertion hole when viewed from the vertical direction,
the upper-half main steam supply path and the lower-half main steam supply path communicate with an outside of the upper-half valve casing and the lower-half valve casing only on one side in the axial direction, and
the upper-half valve casing has
an upper-half valve casing main body in which the inlet flow path, the inlet opening, the exhaust flow path, and the member insertion hole are formed,
an upper-half closing member that is disposed below the upper-half valve casing main body in the vertical direction to form, together with the upper-half valve casing main body, the upper-half main steam supply path, and
a welding portion that fixes the upper-half valve casing main body and the upper-half closing member to each other by welding.

2. The casing according to claim 1, wherein
the upper-half main steam supply path is formed in an arc shape when viewed from the axial direction,
the upper-half valve casing main body has an outer-side inner peripheral surface having at least a part of the outer-side inner peripheral surface that faces downward in the vertical direction in the upper-half main steam supply path, and
the upper-half closing member has an inner-side inner peripheral surface having at least a part of the inner-side inner peripheral surface that faces upward in the vertical direction in the upper-half main steam supply path.

3. The casing according to claim 1, wherein the upper-half valve casing main body, the upper-half closing member, the body block portion, the upper-half flange, and the lower-half flange are formed by forging.

4. The casing according to claim 1, wherein
the lower-half valve casing has a lower-half valve communication hole that is connected to the lower-half main steam supply path and extends in the first direction to communicate with the outside, and
the lower-half flange is disposed to close the lower-half valve communication hole when viewed from the first direction.

5. The casing according to claim 1, further comprising:
an extraction valve casing that is connected to the casing body, the upper-half flange, and the lower-half flange at a position separated from the valve casing in the axial direction, and communicates with an inside of the casing body, wherein
the extraction valve casing has
an upper-half extraction valve casing having an upper surface that faces upward in the vertical direction, an extraction inlet flow path that is open at a position separated from the upper surface in the first direction, a plurality of extraction exhaust flow paths that are open at positions separated from the extraction inlet flow path in the axial direction and at the positions separated from each other on the upper surface in the first direction, and an upper-half extraction supply path that is curved and communicates with a part of the plurality of extraction exhaust flow paths, and
a lower-half extraction valve casing disposed below the upper-half extraction valve casing in the vertical direction and having a lower-half extraction supply path that is curved and communicates with a remaining part of the plurality of extraction exhaust flow paths, and
the upper-half extraction supply path communicates with an outside of the upper-half extraction valve casing only on one side in the axial direction.

6. The casing according to claim 5, wherein
the lower-half extraction valve casing has a lower-half extraction valve communication hole that is connected to the lower-half extraction supply path and extends in the first direction to communicate with an outside of the extraction valve casing, and
the lower-half flange is disposed to close the lower-half extraction valve communication hole when viewed from the first direction.

7. A method for manufacturing a casing including
a valve casing of a regulating valve in which an upper-half valve casing above in a vertical direction and a lower-half valve casing below in the vertical direction are included and a supply amount of steam to be supplied in a steam turbine is adjustable,
a casing body that has an upper-half body above in the vertical direction and a lower-half body below in the vertical direction, is formed in a tubular shape centered on an axis line extending in an axial direction, and is connected to the valve casing,
a pair of upper-half flanges that is connected to the upper-half valve casing and the upper-half body at both end portions in a circumferential direction around the axis line with respect to the upper-half body, and extends in the axial direction, and
a pair of lower-half flanges that is connected to the lower-half valve casing and the lower-half body at both end portions in the circumferential direction with respect to the lower-half body, and extends in the axial direction,
in which the upper-half body and the lower-half body each have a plurality of body block portions arranged in the axial direction,
the upper-half valve casing has
an inlet flow path that allows a valve body to be disposed and is formed in a linear shape in a first direction orthogonal to the vertical direction and the axial direction,
an inlet opening that allows a fluid to flow into the inlet flow path and causes an end portion of the inlet flow path in the first direction to communicate with an outside,
a plurality of exhaust flow paths that communicate with the inlet flow path at positions separated from each other in the first direction such that the fluid in the inlet flow path is caused to flow out in the vertical direction,
a member insertion hole that causes the inlet flow path to communicate with the outside at a position facing the plurality of exhaust flow paths in the vertical direction, and
an upper-half main steam supply path that is curved and communicates with a part of the plurality of exhaust flow paths,
the lower-half valve casing has a lower-half main steam supply path that is curved and communicates with a remaining part of the plurality of exhaust flow paths,
at least a part of the plurality of exhaust flow paths is disposed at a position separated from the member insertion hole when viewed from the vertical direction,
the upper-half main steam supply path and the lower-half main steam supply path communicate with an outside of the upper-half valve casing and the lower-half valve casing only on one side in the axial direction, and
the upper-half valve casing has
an upper-half valve casing main body in which the inlet flow path, the inlet opening, the exhaust flow path, and the member insertion hole are formed,
an upper-half closing member that is disposed below the upper-half valve casing main body in the vertical direction to form, together with the upper-half valve casing main body, the upper-half main steam supply path, and
a welding portion that fixes the upper-half valve casing main body and the upper-half closing member to each other by welding, the manufacturing method comprising:
a step of manufacturing the upper-half valve casing main body and the upper-half closing member; and
a step of welding the upper-half valve casing main body and the upper-half closing member to each other, wherein
in the step of manufacturing, one forged member formed by forging is cut to manufacture the upper-half valve casing main body and the upper-half closing member.
